(19) United States
(12) Patent Application Publication
(10) Pub. No.: US 2025/0105600 A1
(43) Pub. Date: Mar. 27, 2025

(54) SHUTTER ASSEMBLY, LOCKING DEVICE, SWITCHBOARD DOOR, AND SWITCHBOARD INCLUDING SAME

(71) Applicant: LS ELECTRIC CO., LTD., Anyang-si, Gyeonggi-do (KR)

(72) Inventors: Hanjoo LEE, Anyang-si, Gyeonggi-do (KR); Hongik YANG, Anyang-si, Gyeonggi-do (KR); Junyoun JO, Anyang-si, Gyeonggi-do (KR); Moonsub LEE, Anyang-si, Gyeonggi-do (KR)

(21) Appl. No.: 18/578,610

(22) PCT Filed: Jan. 6, 2022
(86) PCT No.: PCT/KR2022/000219

§ 371 Date: Jan. 11, 2024

(30) Foreign Application Priority Data
Jul. 22, 2021 (KR) 10-2021-0096572
Jul. 30, 2021 (KR) 20-2021-0002397

(51) Int. Cl. H02B 11/24; H02B 1/38; H02B 11/133

(52) U.S. Cl. CPC H02B 11/24; H02B 1/38; H02B 11/133

(57) ABSTRACT

The present disclosure relates to a shutter assembly, a locking device, a switchboard door, and a switchboard including same, and provides the switchboard including: a switchboard case which is mounted such that a shutter can be moved to a test position and a connected position; a door which is installed in the switchboard case to be opened or closed; a shutter assembly configured to open or close a terminal disposed inside the switchboard case, as the shutter is moved into the switchboard case; and a locking device which is configured to be disposed in an area caught by the shutter assembly when the shutter assembly is rotated, and is rotated to an area not caught by the shutter assembly as the shutter is moved into the switchboard case, so that the shutter assembly is rotatable.

### TECHNICAL FIELD

The present disclosure relates to a shutter assembly, a locking device, a switchboard door, and a switchboard including the same, and more particularly, a switchboard capable of securing user's safety.

### BACKGROUND ART

In general, a switchboard is a device that is installed at a power plant, a substation, or a place with an electrical utility to monitor, control, protect, etc. an electrical system.

For an operation or control of the power plant and the substation and an operation of a motor, various electric devices such as a circuit breaker, a safety device, an instrument, a display lamp, a relay, and the like are disposed within the switchboard, to facilitate opening/closing of lines or a device control.

The circuit breaker is received in a circuit breaker room of the switchboard, and may be used by being moved to two positions, namely, a run position and a test position.

When the circuit breaker is moved to the rear run position inside the switchboard, a terminal disposed on the rear of the circuit breaker is connected to a terminal disposed on a rear surface of the switchboard, so that current can be supplied toward a load through a main circuit part of the circuit breaker.

When the circuit breaker is moved to the front test position inside the switchboard, the terminal disposed on the rear of the circuit breaker is separated from the terminal disposed on the rear surface of the switchboard. Accordingly, only the operation of the circuit breaker can be tested and no current is supplied to the main circuit part of the circuit breaker.

Therefore, when the circuit breaker is at the test position, even if the user opens the door of the circuit breaker room, there is no worry about exposure to risks such as electric shock because current does not flow in the circuit breaker.

However, in the case of a general switchboard, the user may arbitrarily open the door to the circuit breaker room even when the circuit breaker is at the run position. Accordingly, when high voltage is applied to the main circuit part of the circuit breaker, the user is exposed to the high voltage current of the circuit breaker, which may cause a safety accident, such as electric shock, etc.

In order to overcome (or improve) the above problem, the applicant of the present disclosure has developed a door lock device, which allows a door of a circuit breaker room to be open only when the circuit breaker is located at a test position and suppresses the door of the circuit breaker room from being open when the circuit breaker is at a run position, and a circuit breaker using the same.

FIG. 36 is a schematic diagram illustrating an operating state of a related art door lock device. A lock bar 1, which is a component of the door lock device, has one end portion is a fixed end fixed to one end portion of a rotation plate 2, and another end portion is a free end extending long from the fixed end in a vertical (up/down) direction. The lock bar 1 is moved down from a door unlock position to a door lock position in conjunction with the rotation plate 2.

Regarding an operating state of the door lock with reference to FIG. 36, when a circuit breaker moves to a run position of the rear of the switchboard, a lock plate 7 coupled to a top of a front cover 6 of a circuit breaker body moves rearward and presses one end portion of the rotation plate 2 (S1).

The pressed rotation plate 2 rotates around a rotation pin 3 (S2), and another end portion of the lock bar 1 descends to be inserted into a guide hole 5a of a door lock 5 attached to a door 4 (S3).

The door lock 5 is caught by the lock bar 1 to prevent the door 4 from being open arbitrarily when the circuit breaker is at the run position.

However, the technology has the following problems.

Since the lock bar 1 has a long length between the fixed end and the free end and a small diameter compared to the length, a locking position of the lock bar 1 may be changed due to slight bending caused by an external impact.

Also, since the door lock 5 is made of a plate structure which is long between the fixed end and the free end and is thin in thickness, the position of the guide hole 5a of the door lock 5 may be changed due to slight bending caused by an external impact.

In addition, an insertion position of the lock bar 1 may be changed due to bending caused by repetitive load or assembly tolerances.

As a result, the door locking operation is not performed properly or the door locking operation is incomplete even if the door lock operation is performed. Accordingly, the lock bar 1 may be separated from the guide hole 5a of the door lock 5 upon a door opening operation, which may cause a result that the door lock device does not properly execute its original function.

### DISCLOSURE OF INVENTION

### Technical Problem

Therefore, the present disclosure has been devised to solve the above problems, and one aspect of the present disclosure is to provide a shutter assembly, a locking device, a switchboard door, and a switchboard including the same, capable of releasing a lock for a rotation of the shutter assembly, locking a door, and rotating the shutter assembly, as a circuit breaker is introduced into a switchboard case.

Another aspect of the present disclosure is to provide a switchboard door capable of locking a door handle portion as a circuit breaker is introduced into a switchboard case.

Still another aspect of the present disclosure is to provide a switchboard door, capable of unlocking a door handle portion in a locked state in a simple manner when there is a need to open the switchboard door after a circuit breaker is introduced into a switchboard case.

### Solution to Problem

In order to achieve those aspects and other advantages of the present disclosure, there is provided a shutter assembly that is connected to a switchboard to open and close a terminal of an external terminal disposed in the switchboard to be connected to a circuit breaker. The shutter assembly includes a plurality of shutter plates that shield an upper terminal and a lower terminal, a plurality of shutter levers, each of which is connected to the shutter plate at one end thereof and is rotatable, and a connection link that connects the plurality of shutter levers and is movable so that the shutter levers rotate, and the plurality of shutter levers are configured to rotate in different directions so that the plurality of shutter plates rotate in different directions.

The plurality of shutter plates may include an upper shutter plate that blocks the external terminal disposed at a top, and a lower shutter plate that blocks the external terminal disposed at a bottom.

Additionally, the upper shutter plate and the lower shutter plate may include wings that are bent concavely to both sides to reduce a rotated region.

The shutter levers may include an upper shutter lever that is connected to the upper shutter plate, and a lower shutter lever that is connected to the lower shutter plate.

The upper shutter lever and the lower shutter lever may include rotation axis pins that rotate the upper shutter lever and the lower shutter lever, respectively.

The rotation axis pins of the upper shutter lever and the lower shutter lever may be disposed at the same position of each lever.

The shutter assembly may further include a main link that is connected to the connection link to move the connection link downward when the circuit breaker is inserted.

The main link may be disposed in a path along which the circuit breaker is inserted into the switchboard, and pressed by at least a portion of the circuit breaker as the circuit breaker is inserted, to be rotated centering on one axis.

The main link may include a stopping jaw by which a wheel of the circuit breaker is caught and is rotated when the wheel of the circuit breaker enters more inward than the stopping jaw.

The connection link may include an upper connection link that connects the upper shutter lever and the lower shutter lever to each other, and a lower connection link that connects the lower shutter lever and the main link to each other.

The upper connection link and the lower connection link may be connected to the upper shutter lever and the lower shutter lever, respectively, at a position farthest away from the rotation axis pin in a remaining region, excluding at least a portion from a region of connecting the rotation axis pin and the shutter plate, so as to be connected to the shutter plates.

The upper connection link may be connected to the upper shutter lever at a side far away from the shutter plate based on the rotation axis pin, and the lower connection link may be connected to the lower shutter lever at a side close to the shutter plate based on the rotation axis pin.

In order to achieve those aspects and other advantages of the present disclosure, there is provided a locking device that is disposed inside a switchboard to lock or unlock a shutter assembly for opening or closing a terminal of an external terminal. The locking device includes a rotation part that is disposed adjacent to the shutter plate and is rotatable, a shutter locking plate coupled to the rotation part and rotated in response to rotation of the rotation part, a connecting rotation plate that is disposed to be spaced apart from the rotation part and rotated by being pressed by a circuit breaker body during a process that the circuit breaker is inserted into the switchboard, and a connecting rod that is coupled to each of the rotation part and the connecting rotation plate to transmit rotational force generated by the connecting rotation plate to the rotation part. The shutter locking plate is disposed in a blocking area, in which the shutter locking plate blocks the shutter plate, before the connecting rotation plate is rotated by the circuit breaker, and is rotatable to outside of the blocking area of the shutter plate when the circuit breaker is inserted into the switchboard and the connecting rotation plate is rotated by the circuit breaker.

The circuit breaker may change a position to a first state in which the circuit breaker is disposed in a disconnected state inside the switchboard, a second state in which the circuit breaker is disposed in a test state inside the switchboard, and a third state in which the circuit breaker is disposed in a connected state connected to the external terminal inside the switchboard, and the connecting rotation plate may be configured to be pressed by the circuit breaker body in the process that the circuit breaker is switched from the second state to the third state.

The rotation part may include a fixed plate that is fixed to a fixing portion inside the switchboard, adjacent to the shutter plate, a lower plate that is disposed adjacent to a lower surface of a switchboard case corresponding to the fixing plate, a rotation rod that has one side coupled to the fixed plate and another side coupled to the lower plate and is rotatable, and a rotation part plate that is coupled to be rotatable relative to the lower plate and rotatable in response to rotation of the rotation rod.

In addition, the connect rod may have one side connected to the rotation plate and another side connected to the connecting rotation plate, and transmits power to the rotation part plate so that the rotation part plate rotates as the connecting rotation plate rotates.

The connecting rod may include a first groove, a second groove, and a third groove that are formed in a line in one end thereof connected to the rotation part plate and disposed to be spaced apart from one another. The rotation part plate may include a first hole that is formed at a position corresponding to the first groove as the rotation part plate is rotated in one direction, a second hole that is connected to the second groove by a rotation pin and serves as a center of a rotation axis, and a third hole that is formed at a position corresponding to the third groove as the rotation part plate is rotated in another direction.

In addition, when a locking pin is inserted into the first groove and the first hole at a position where the first groove of the connecting rod and the first hole of the rotation part plate are aligned with each other, the shutter locking plate may be fixedly disposed within a radius at which the shutter plate is rotated. On the other hand, when the locking pin is inserted into the third groove and the third hole at a position where the third groove of the connecting rod and the third hole of the rotation part plate are aligned with each other, the shutter locking plate may be fixedly disposed outside the radius at which the shutter plate is rotated.

The shutter assembly may further include a door locking rod that has one end connected to the connecting rotation plate, and the door locking rod may be coupled to a portion opposite to a portion where the connecting rod is coupled to the connecting rotation plate, so as to be moved in an opposite direction to the connecting rod during the rotation of the connecting rotation plate.

The door locking rod may include a connecting portion protruding to one side thereof, and the connecting portion may be configured such that a coupling bolt to be coupled to the connecting rotation plate is fastened thereto.

The shutter assembly may further include a door locking plate that is coupled to another end of the door locking rod and extends in a direction parallel to a lengthwise direction of the door locking rod, and the door locking plate may be moved in the lengthwise direction of the door locking rod to be inserted into a door locking plate insertion groove formed in a door, in response to the rotation of the connecting rotation plate.

Additionally, the door locking plate may include a first body connected to the door locking rod by a coupling member, and a second body extending from the first body and bent to further extend.

In order to achieve those aspects and other advantages of the present disclosure, there is provided a switchboard including a switchboard case in which a circuit breaker is mounted to be movable to a test position and a connected position, a door that is installed on the switchboard case to be open and closed, a shutter assembly that is configured to open and close terminals disposed inside the switchboard case as the circuit breaker is moved into the switchboard case, and a locking device that is disposed in a region where the same locks the shutter assembly when the shutter assembly is rotated, and rotated to a region where the same does not lock the shutter assembly to allow the shutter assembly to be rotated as the circuit breaker is moved into the switchboard case.

The shutter assembly may include a plurality of shutter plates that shield an upper terminal and a lower terminal, a plurality of shutter levers, each of which has one end connected to the shutter plate and is rotatable, a connection link that connects the plurality of shutter levers and is movable so that the shutter levers rotate, a main link that is connected to the connection link to move the connection link downward when the circuit breaker is inserted, and the plurality of shutter levers may be configured to be rotated in different directions so that the plurality of shutter plates are rotated in different directions.

The locking device may include a rotation part that is disposed adjacent to the shutter plate of the shutter assembly and is rotatable, a shutter locking plate that is coupled to the rotation part and rotated in response to rotation of the rotation part, a connecting rotation plate that is disposed to be spaced apart from the rotation part and rotated by being pressed by a circuit breaker body during a process that a circuit breaker is inserted into the switchboard, and a connecting rod that is coupled to each of the rotation part and the connecting rotation plate to transmit rotational force generated by a second rotation plate to a first rotation plate. The shutter locking plate may be disposed in a blocking area, in which the shutter locking plate blocks the shutter plate, before the connecting rotation plate is rotated by the circuit breaker, and may be rotatable to outside of the blocking area of the shutter plate when the circuit breaker is inserted into the switchboard and the connecting rotation plate is rotated by the circuit breaker.

Additionally, the main link of the shutter assembly may be disposed closer to the circuit breaker than the connecting rotation plate of the locking device.

The main link may include a stopping jaw by which a wheel of the circuit breaker is caught, and may be rotated when the wheel of the circuit breaker enters more inward than the stopping jaw. The stopping jaw of the main link of the shutter assembly may be disposed closer to a rear surface of the switchboard case than the connecting rotation plate.

Also, the locking device may further include a door locking rod that suppresses the door from being arbitrarily open when the circuit breaker moves to the run position.

In order to achieve those aspects and other advantages of the present disclosure, there is provided a switchboard door that is connected to a front surface of the switchboard case and disposed to open and close the switchboard case. The switchboard door includes a door cover that is rotatable relative to the switchboard case, a door handle portion that is disposed on one side of the door cover and is open or closed to lock or unlock the door cover with respect to the switchboard case, and a door sliding plate that is movable in one direction in conjunction with an opening or closing operation of the door handle portion. The door cover includes a door locking plate insertion groove through which a door locking rod is inserted, the door locking rod protruding toward the door cover or being drawn in according to an inserted state of the circuit breaker into the switchboard case.

The door cover may further include a hinge member that is coupled to the switchboard case and serves as a rotation axis of the door cover, and a door cover edge portion that is disposed on an opposite side to a side where the hinge member is disposed, and protrudes toward an inside of the door cover. The door locking plate insertion groove may be formed at a position corresponding to the door locking rod at the door cover edge portion.

In addition, the door sliding plate may further include a door interlock plate portion that is disposed to cover or not to cover the door locking plate insertion groove as the door sliding plate is moved up and down.

The door interlock plate portion may include a connection plate that has one end coupled to the door sliding plate to be movable together with the door sliding plate as the door sliding plate is moved up and down, a door interlock plate that is coupled to another end of the connection plate, and is disposed at a first position to open the door locking plate insertion groove when the door handle portion is in a closed state while being disposed at a second position to close the door locking plate insertion groove when the door handle portion is in an open state, and a coupling member that couples the connection plate and the door interlock plate to each other.

The circuit breaker may change a position to a first state in which the circuit breaker is disposed in a disconnected state inside the switchboard, a second state in which the circuit breaker is disposed in a test state inside the switchboard, and a third state in which the circuit breaker is disposed in a connected state connected to an external terminal inside the switchboard. The door locking rod may be inserted through the door locking plate insertion groove in the process that the circuit breaker is switched from the second state to the third state. The door interlock plate may be restricted from being moved from the first position to the second position by the door locking rod, which is pulled out through the door locking plate insertion groove, when the door locking rod is disposed in a state inserted through the door locking plate insertion groove.

The coupling member may be disposed in a direction toward the door cover to be detachable in the direction toward the door cover, and the door cover may include a through hole formed at a position corresponding to the coupling member when the coupling member is located at the first position.

The door cover may further include a through hole stopper that is at least partially fitted into the through hole and detachable from the through hole.

A fastening tool that is capable of separating the coupling member, which couples the door interlock plate and the connection plate, may pass through the through hole.

In addition, when the door interlock plate is separated from the connection plate, the door sliding plate may be moved upward as the door handle portion is switched from a closed state to an open state after the door locking rod is inserted through the door locking plate insertion groove.

### Advantageous Effects of Invention

As described above, according to one embodiment of the present disclosure, a shutter plate includes wings, so that a space for rotation of the shutter plate can be reduced. Through this, the shutter plate can be rotated effectively even in a small space without interfering with other components.

According to one embodiment of the present disclosure, a rotation axis pins of upper and lower shutter levers can be disposed vertically on the same line, so that the upper shutter lever and the lower shutter lever can be easily rotated by one connection link.

According to one embodiment of the present disclosure, an upper connection link and a lower connection link can be connected to respective shutter levers at farthest positions in remaining regions of the shutter levers, except for regions where the shutter levers are connected to the shutter plate, respectively, based on the rotation axis pins, thereby increasing moments transmitted to the shutter levers when the connection links move. Accordingly, the shutter levers can be easily rotated by the connection links.

According to one embodiment of the present disclosure, the upper connection link is connected to the upper shutter lever at a side far from the shutter plate based on the rotation axis pin, and the lower connection link is connected to the lower shutter lever at a side close to the shutter plate based on the rotation axis pin. Accordingly, when the lower connection link is moved downward, the lower connection link and the upper connection link can be moved so as to rotate the upper shutter plate and the lower shutter plate in different directions, respectively.

According to one embodiment of the present disclosure, a door locking rod can prevent a door from being arbitrarily open when a circuit breaker moves to a run position.

In a switchboard according to one embodiment of the present disclosure, a stopping jaw of a main link can be disposed closer to a rear surface of a switchboard case than a connecting rotation plate, so that a shutter assembly can be rotated after its locked state is unlocked by a locking device. Through this, the locking device can first unlock the shutter assembly and then the shutter assembly can unlock an external terminal.

According to one embodiment of the present disclosure, a door locking rod can prevent a door from being arbitrarily open when a circuit breaker moves to a run position.

In a switchboard according to one embodiment of the present disclosure, as the switchboard is inserted, a door locking plate can be inserted into a door cover, so as to lock a door handle portion which is in a locked state, from being switched to an open state. Through this, according to a position of the switchboard inside the switchboard case, the door locking rod and the door locking plate can be inserted into the door cover, and the door handle portion can be locked not to be switched from the locked state to the open state.

In a switchboard according to one embodiment of the present disclosure, by virtue of a through hole and a through hole stopper disposed at the door cover, a door sliding plate and a door interlock plate can be separated from each other, so as to allow upward and downward movement of the door sliding plate. That is, by separating the door sliding plate and the door interlock plate portion from each other, the door handle portion locked by the door locking rod and the door locking plate can be unlocked.

That is, when the door handle portion is in the locked state by the door locking rod and the door locking plate, the door sliding plate and the door interlock plate portion can be separated from each other through the through hole formed in the door cover, thereby releasing the locked state of the door handle portion.

Through this, when the door handle portion is in the locked state due to the switchboard disposed inside the switchboard case and simultaneously it is necessary to separate the door cover from the switchboard case, the door sliding plate and the door interlock plate portion can be separated from each other by removing the through hole stopper disposed on the door cover. This can provide an advantage of releasing the locked state of the door handle portion in a simple way.

### BRIEF DESCRIPTION OF DRAWINGS

FIG. 1 is a perspective view illustrating a switchboard in accordance with one embodiment of the present disclosure.

FIG. 2 is a perspective view illustrating a state in which a door and a switchboard side plate are removed from the switchboard of FIG. 1 and a circuit breaker is disposed at a disconnected position.

FIG. 3 is a perspective view illustrating a state in which the circuit breaker is disposed at a test position in the switchboard of FIG. 2.

FIG. 4 is a perspective view illustrating a state in which the circuit breaker is disposed at a connected position in the switchboard of FIG. 2.

FIG. 5 is a perspective view illustrating a state in which the circuit breaker is removed from the switchboard of FIG. 2.

FIG. 6 is a perspective view illustrating a shutter assembly in accordance with one embodiment of the present disclosure.

FIGS. 7A and 7B are perspective views illustrating a state in which a circuit breaker is closed in the course of moving from a test position to a connected position on a shutter assembly in accordance with one embodiment of the present disclosure.

FIGS. 8A and 8B are perspective views illustrating a state in which a circuit breaker is closed in the course of moving from a test position to a connected position on a shutter assembly in accordance with another embodiment of the present disclosure.

FIG. 9 is a perspective view illustrating a locking device in accordance with one embodiment of the present disclosure.

FIG. 10 is a view illustrating a state ((a) and (c)) before the locking device of FIG. 9 is rotated by a circuit breaker and a state ((b) and (d)) after the locking device is rotated by the circuit breaker.

(a) of FIG. 11 is a planar view illustrating a rotation part plate, and (b) of FIG. 11 is a planar view illustrating a connecting rod.

FIG. 12 is a planar view illustrating a state in which a shutter locking plate is rotated to outside of a blocking area, in response to rotation of a rotation part plate of the locking device of FIG. 9.

FIG. 13 is a perspective view illustrating a door locking rod and a door locking plate in accordance with one embodiment of the present disclosure.

FIG. 14 is a perspective view illustrating a state, viewed from a different direction, in which the switchboard side plate is removed from the switchboard of FIG. 1 and the circuit breaker is disposed at the disconnected position.

FIG. 15 is an enlarged view of a portion A of FIG. 14, namely, a partially enlarged view of a state (a) before the rotation of the locking device, and a state (b) after the rotation of the locking device.

FIG. 16 is a diagram illustrating a rear surface of a door cover in accordance with one embodiment of the present disclosure.

FIGS. 17 and 18 are diagrams illustrating a door sliding plate and door handle portion shown in FIG. 16.

FIGS. 19 to 23 are diagrams illustrating an initial state in which a circuit breaker is moved from a test position to a connected position (run position) in a switchboard according to one embodiment of the present disclosure.

FIGS. 24 to 29 are diagrams illustrating an intermediate state in which a circuit breaker is moved from a test position to a connected position (run position) in a switchboard according to one embodiment of the present disclosure.

FIG. 30 is a diagram illustrating a state in which a circuit breaker is moved very close to a connected position (run position) in a switchboard according to one embodiment.

FIG. 31 is a perspective view illustrating a state in which a portion of a door and a switchboard side plate are removed from a switchboard.

FIG. 32 is a view illustrating a door locking rod and a portion of a door cover by enlarging a one-dot chain line of FIG. 31.

FIG. 33 is an exploded view illustrating some components of the door cover of FIG. 32.

FIG. 34 is a diagram illustrating a stat in which a door handle portion is switched from a closed state to an open state after removing a door interlock plate from a door sliding plate in FIG. 33.

FIG. 35 is a diagram illustrating a state after the door sliding plate is moved as the door handle portion is switched from the closed state to the open state in FIG. 34.

FIG. 36 is a schematic view of a door lock device according to the related art.

### MODE FOR THE INVENTION

Hereinafter, embodiments of the present disclosure will be described in detail with reference to the attached drawings, so as to be easily implemented by those skilled in the art.

In the following description, a description of some components will be omitted to help understanding of the present disclosure.

### 1. Definition of Terms

The term “electrical connection” used in the following description refers to that current or an electrical signal is transmitted between one or more members.

The term “air circuit breaker” used in the following description refers to a circuit breaker configured to extinguish an arc using air or compressed air. Each configuration described below is assumed to be applied to an air circuit breaker.

However, each configuration described below may also be applied to air blast circuit breakers, compressed air circuit breakers, gas circuit breakers, oil circuit breakers, and vacuum circuit breakers.

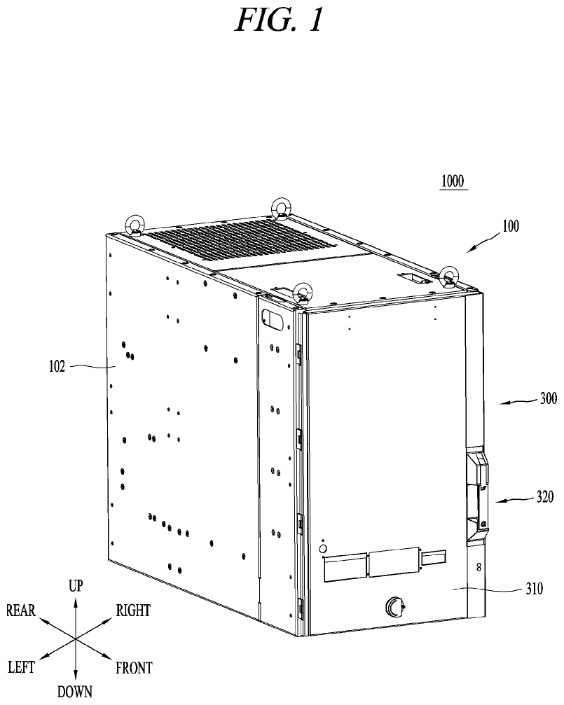

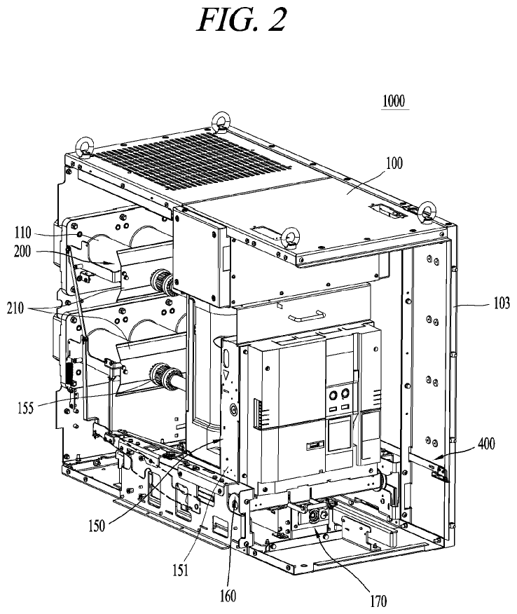

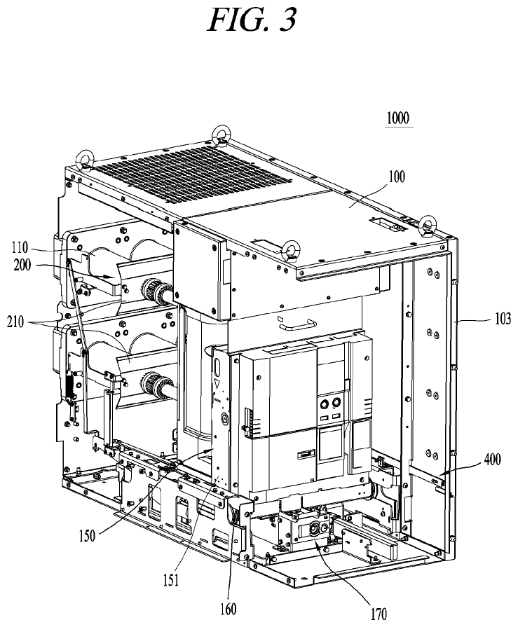

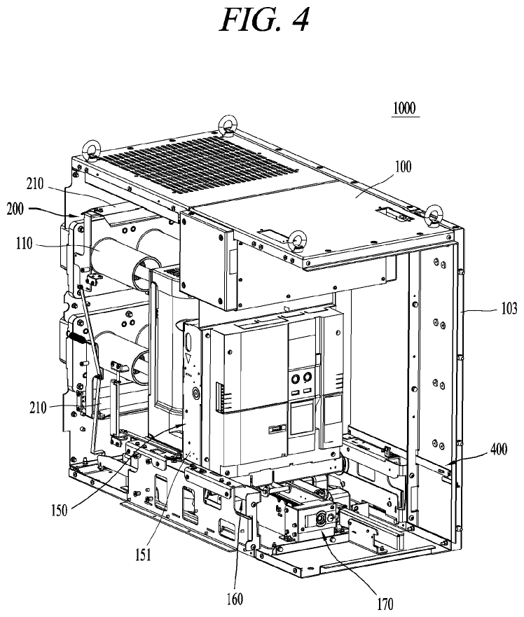

The terms “top”, “bottom”, “right”, “left”, “front” and “rear” used in the following description will be understood based on a coordinate system illustrated in FIG. 1.

### 2. Switchboard 1000

A switchboard 1000 according to one embodiment of the present disclosure may include a switchboard case 100, a door 300, a shutter assembly 200, and a locking device 400.

The switchboard case 100 is mounted such that a circuit breaker 150 is movable to a test position and a connected position. The switchboard case 100 may have a rectangular box structure. The switchboard case 100 may be provided with a side plate 102. A circuit breaker room for keeping (receiving, storing) the circuit breaker 150 may be defined inside the switchboard case 100.

The circuit breaker room may be open to the front of the switchboard case 100. The door 300 may be provided with a hinge at one edge thereof to be coupled to one edge of the switchboard case 100 in a hinged structure, and may be rotatable like a hinged door to open and close an opening of the switchboard case 100.

The circuit breaker body 151 may include a vacuum interrupter that includes movable contact portion and a fixed contact portion within a vacuum container to open and close a current flow path.

An external terminal 110, a circuit breaker entry rail 160, a circuit breaker moving unit 170, etc. may be disposed inside the switchboard case 100.

The external terminal 110 is disposed on a rear surface of the switchboard case 100. When the circuit breaker main body 151 is moved to the rear of the switchboard case 100, that is, to a run position, the external terminal 110 and a circuit breaker terminal 155 may be connected, so that current can be supplied toward a load through a main circuit part of the circuit breaker 150.

In addition, when the circuit breaker main body 151 is moved to the front of the switchboard case 100, that is, to a test position, the external terminal 110 and the circuit breaker terminal 155 may be separated, so as to block the current supply to the main circuit part of the circuit breaker 150.

The circuit breaker 150 may be transported in front and rear directions, namely, to the test position (front) and the run position (rear) inside the switchboard case 100 by a circuit breaker transport unit 170.

The circuit breaker transport unit 170 may be provided with a moving frame for supporting a lower end portion of the circuit breaker 150, and moving wheels on edge portions of both side surfaces of the moving frame, to smoothly transport the circuit breaker 150 in the front and rear directions inside the switchboard case 100.

The circuit breaker entry rail 160 may guide the circuit breaker 150 while the circuit breaker 150 is moved by the circuit breaker transport unit 170.

Additionally, a shutter assembly 200 and a locking device 400 may be disposed in the switchboard 1000. This will be described in detail later.

<Switchboard Case Groove 103a>

Meanwhile, a switchboard case groove 103a may be formed in a front edge 103 of the switchboard case 100.

The switchboard case groove 103a is provided with an open groove along which a portion of the locking device 400 is moved toward the door 300 as the locking device 400 is pressed by the movement of the circuit breaker 150 inside the switchboard case 100.

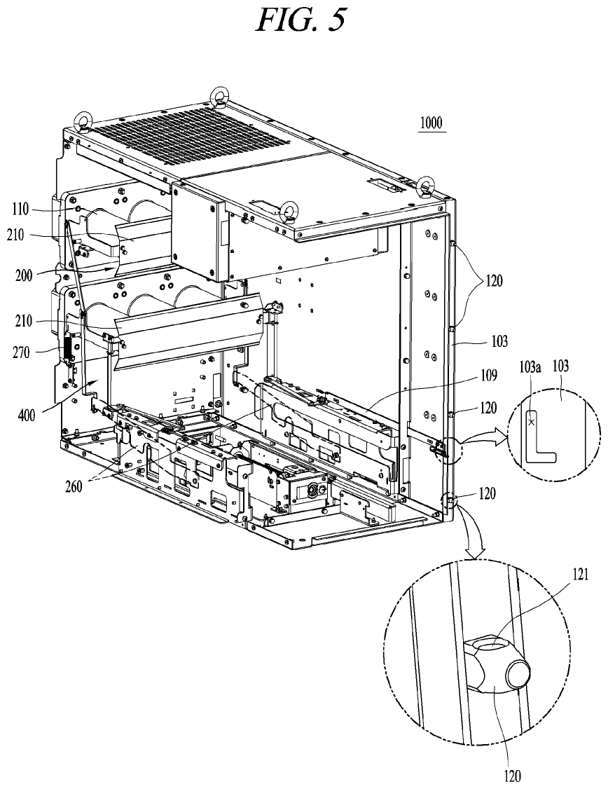

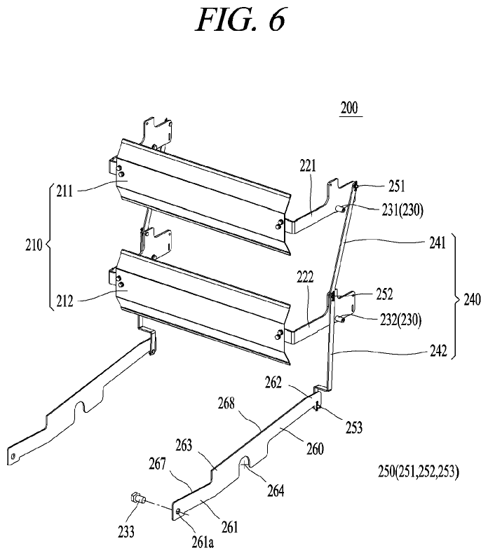

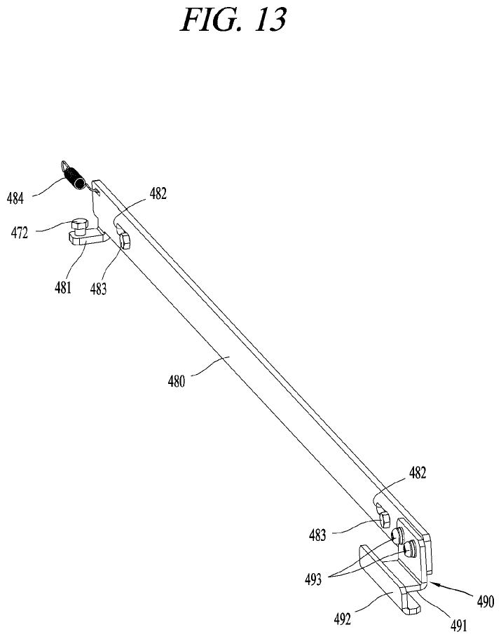

Referring to FIGS. 5 and 13, a door locking plate 490 of the locking device 400 may penetrate through the switchboard case groove 103a formed in the front edge 103 of the switchboard case 100.

### <Door 300>

The door 300 is disposed on a front surface of the switchboard case 100. Referring to FIG. 1, the door 300 is disposed to cover the switchboard case 100.

Additionally, the door 300 may be fixed to one side with respect to the switchboard case 100 and another side may be installed to be open and closed in a rotating manner.

Referring to FIG. 16, the door 300 may include a door cover 310. A hinge member 312 may be installed on one side of the door cover 310 to fix the door cover 310 to the switchboard case 100. The door cover 310 may be rotatable relative to the switchboard case 100 centering on the hinge member 312. That is, the door cover 310 may be rotated centering on the hinge member 312 as an axis.

A door cover edge portion 311 may protrude toward the inside of the door cover 310 from an opposite side of the door cover 310 to the one side where the hinge member 312 is disposed.

A door locking plate insertion groove 311a through which a door locking plate 490 to be described later can be inserted may be formed in the door cover edge portion 311. The door locking plate 490 may be inserted into or pulled out of the door locking plate insertion groove 311a described above. At this time, the door locking plate insertion groove 311a is formed in the door cover edge portion 311 at a position corresponding to the door locking rod 480.

When the door locking plate 490 is inserted into the door locking plate insertion groove 311a, the door handle portion 320 may not be closed. When the door locking plate 490 is pulled out of the door locking plate insertion groove 311a, the door handle portion 320 may be closed.

The door handle portion 320 may be disposed on the opposite side of the door cover 310 to the one side where the hinge member 312 is installed. The door handle portion 320 is installed on a surface opposite to the surface where the hinge member 312 is disposed. By opening and closing the door handle portion 320, that is, by opening or closing the door handle portion 320, the door cover 310 can be locked or unlocked with respect to the switchboard case 100.

An upper end portion of the door handle portion 320 is coupled to the door 300 in a hinged structure, and thus its lower end portion is rotatable forward. A door handle 321 of the door handle portion 320 may be pulled forward by the user's hand. Additionally, when the door handle portion 320 is released, it may be moved back to its original position by an operation return element such as a spring disposed inside the door handle portion 320.

A door locking unit may be disposed on a side surface of the door 300. The door locking unit may be moved to a door lock position and a door unlock position in conjunction with the door handle portion 320. The door cover 310 may be locked to the switchboard case 100 or unlocked from the switchboard case 100 by the door locking unit. For example, when the door handle portion 320 is pulled forward, the door locking unit may be unlocked from the switchboard case 100 and the door 300 can be open. Conversely, when the door handle portion 320 is returned to its original position after closing the door 300, the door 300 may be locked by the door locking unit.

In addition, the door 300 further includes a door sliding plate 340 that moves up and down as the door handle portion 320 is open and closed.

The door sliding plate 340 moves upward when the door handle 321 of the door handle portion 320 is open, while moving downward when the door handle 321 of the door handle portion 320 is closed. That is, the door sliding plate 340 is configured to be movable up and down in one direction in conjunction with the opening or closing operation of the door handle portion 320. However, in another embodiment, the door sliding plate 340 may be movable to left and right or in an oblique direction.

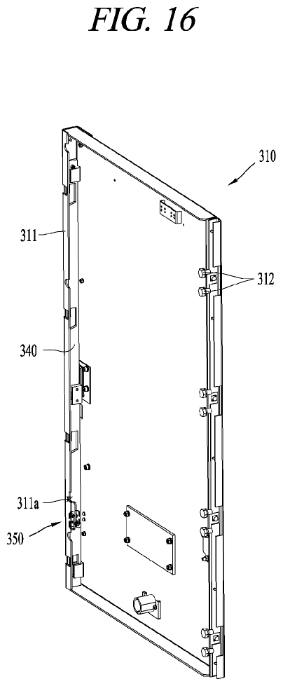

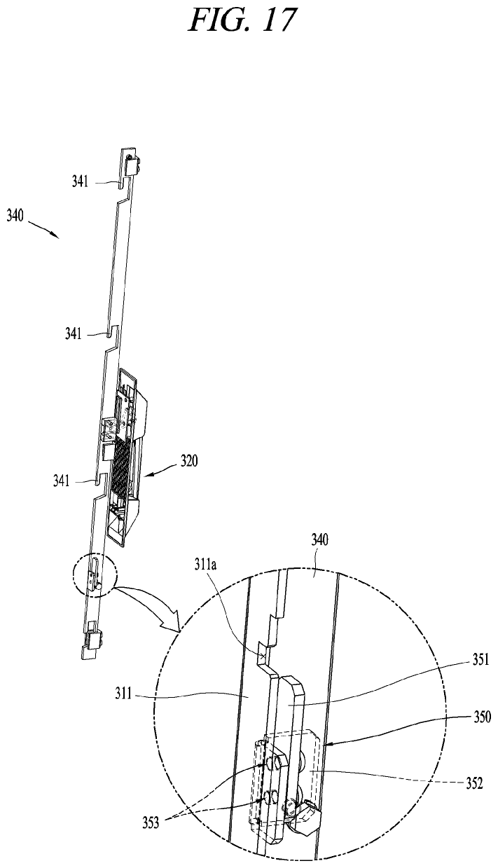

Referring to FIG. 17, a plurality of door lock pins 341 may be disposed on the door sliding plate 340. The door lock pins 341 may be spaced apart up and down on the door sliding plate 340, and have a shape protruding downward in a plurality of concave grooves 340a.

As the door sliding plate 340 is moved downward, the door lock pins 341 may be inserted into door lock pin insertion portions 120 that are disposed in the front edge 103 of the switchboard case 100.

Specifically, referring to FIGS. 5 and 17, the door lock pins 341 of the door sliding plate 340 may be inserted into the door lock pin insertion grooves 121 formed in the door lock pin insertion portions 120 disposed in the switchboard case 100, such that the door cover 310 and the switchboard case 100 can be locked to each other.

That is, after closing the door cover 310 in close contact with the switchboard case 100, the door sliding plate 340 may be moved downward by closing the door handle portion 320 of the door cover 310. As the door sliding plate 340 is moved downward, the door lock pins 341 of the door sliding plate 340 are inserted into the door lock pin insertion grooves 121. Accordingly, the door cover 310 and the switchboard case 100 can be locked to each other. A mechanism in a reverse order may be applied to unlock the door cover 310 from the switchboard case 100.

### <Shutter Assembly 200>

The shutter assembly 200 may be configured to open and close a terminal disposed inside the switchboard case 100, in response to the movement of the circuit breaker 140 into the switchboard case 100.

The circuit breaker 150 may change its position inside the switchboard 1000 to a first state in which the circuit breaker 150 is disposed in a disconnected state, a second state in which the circuit breaker 150 is disposed in a test state, and a third state in which the circuit breaker 150 is disposed in a connected state connected to an external terminal 110.

The shutter assembly 200 may block the external terminal 110 or release the blocked external terminal 110 to be connected to the circuit breaker 150, depending on the position of the circuit breaker 150 (disconnected position-first state, test position-second state, and connected position-third state).

Specifically, when the circuit breaker 150 is located at the disconnected position and the test position, the shutter assembly 200 may be disposed to disconnect (block) the external terminal 110 to suppress an occurrence of an accident which may be caused when current flows on the external terminal 110.

In addition, the shutter assembly 200 may release the blocked external terminal 110 to be connected to the circuit breaker 150 while the circuit breaker 150 moves from the test position to the connected position (run position, electrically-connected position). This will be described in detail later.

### <Locking Device 400>

The locking device 400 is disposed in a region where it locks (blocks) the shutter assembly 200 when the shutter assembly 200 is rotated. Additionally, the locking device 400 may be rotated to a region where it does not lock (block) the shutter assembly 200, so that the shutter assembly 200 can be rotated as the circuit breaker 150 moves inside the switchboard case 100.

That is, the locking device 400 may lock or unlock the movement of the shutter assembly 200 so that the shutter assembly 200 is not rotated or is rotated. This can suppress an accident in advance from occurring due to the rotation of the shutter assembly 200 in an uncontrolled situation. This will be described in detail later.

The locking device 400 is disposed in a region where it locks the shutter assembly 200 when the shutter assembly 200 is rotated. Specifically, when the shutter assembly 200 moves from a locked state to an unlocked state, the shutter assembly 200 may be locked by the locking device 400.

### 3. Shutter Assembly 200

The shutter assembly 200 according to one embodiment of the present disclosure is configured to open and close a terminal of the external terminal 110 disposed inside the switchboard 1000.

Specifically, the shutter assembly 200 includes a plurality of shutter plates 210, a plurality of shutter levers 220, and a connection link 240. And the shutter assembly 200 may include a main link 260.

### <Shutter Plate 210>

The shutter plate 210 is configured to shield an upper terminal and a lower terminal.

Specifically, referring to FIG. 5 and the like, the shutter plate 210 may be disposed on a front surface of the external terminal 110 to block the external terminal 110.

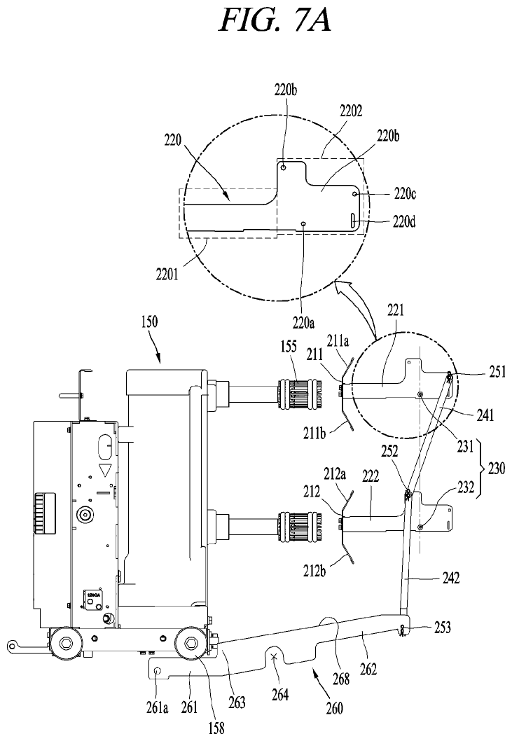

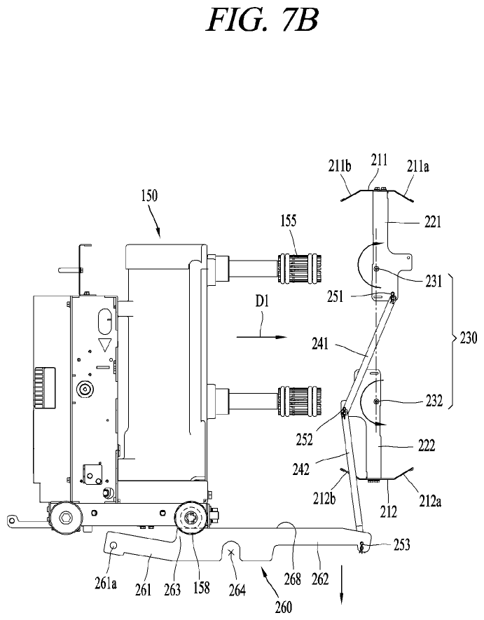

And, referring to FIG. 7B, the shutter plate 210 may be rotated toward a top or bottom of the external terminal 110 so that the front surface of the external terminal 110 is exposed as other components rotate. By the rotation of the shutter plate 210, the external terminal 110 may be open to be electrically connected to a circuit breaker terminal 155.

The plurality of shutter plates 210 may include an upper shutter plate 211 that blocks the external terminal 110 disposed at the top, and a lower shutter plate 212 that blocks the external terminal 110 disposed at the bottom. However, there may be three or more shutter plates 210. That is, the upper shutter plate 211 or the lower shutter plate 212 may be formed separately into two or more parts as needed.

The upper shutter plate 211 and the lower shutter plate 212 may include wings that are bent concavely and extend to both sides to reduce a rotation region.

Referring to FIG. 7A and the like, the upper shutter plate 211 and the lower shutter plate 212 may include wings that are bent from both ends to extend toward the rear surface of the switchboard 1000 in a state before rotation.

Specifically, the upper shutter plate 211 includes an upper shutter plate upper wing 211a and an upper shutter plate lower wing 211b, and the lower shutter plate 212 includes a lower shutter plate upper wing 212a and a lower shutter plate lower wing 212b.

Since the shutter plate 210 includes the wings as described above, a rotation space of the shutter plate 210 can be reduced during the rotation from FIG. 7A to FIG. 7B. Through this, the shutter plate 210 can be effectively rotated even in a small space without interfering with other components.

### <Shutter Lever 220>

The shutter lever 220 has one end connected to the shutter plate 210 and is rotatable.

Specifically, the shutter lever 220 may include an upper shutter lever 221 connected to the upper shutter plate 211, and a lower shutter lever 222 connected to the lower shutter plate 212.

Referring to FIG. 7A, the shutter lever 220 may include a rotation groove 220a, a first groove 220b, a second groove 220c, and a third groove 220d. The rotation groove 220a is a groove into which a rotation axis pin 230, which fixes the shutter lever 220 to the switchboard case 100 and serves as a center of rotation of the shutter lever 220, is inserted.

The first groove 220b is a groove in which the connection link 240 is connected to the lower shutter lever 222. The second groove 220c is a groove in which the connection link 240 is connected to the upper shutter lever 221. The third groove 220d is a groove in which the lower shutter lever 222 is connected to an elastic member 270. At this time, the elastic member 270 may be connected to the switchboard case 100. Accordingly, the elastic member 270 may apply restoring force to the lower shutter lever 222.

The shutter lever 220, that is, the upper shutter lever 221 and the lower shutter lever 222, are configured to be rotated in different directions so that the plurality of shutter plates 210 are rotated in different directions.

Specifically, referring to FIGS. 7A and 7B, the upper shutter lever 221 and the lower shutter lever 222 are rotated in different directions toward the top and the bottom, respectively. Through this, the external terminal 110 can be open.

The upper shutter lever 221 and the lower shutter lever 222 may include rotation axis pins 230, respectively, for rotating the upper shutter lever 221 and the lower shutter lever 222.

Specifically, referring to FIG. 7A, each of the upper shutter lever 221 and the lower shutter lever 222 may have a rotation axis pin 230 disposed toward a rear surface of a lower center of the shutter lever 220. The upper shutter lever 221 and the lower shutter lever 222 rotate centering on the rotation axis pins 230 thereof, respectively.

Specifically, referring to FIGS. 7A and 7B, the upper shutter lever 221 rotates upward centering on the first rotation axis pin 231. And the lower shutter lever 222 rotates downward centering on the second rotation axis pin 232. In addition, a main link rotation pin 233 for fixing the main link 260 to the switchboard may be included.

At this time, the rotation axis pins 230 of the upper shutter lever 221 and the lower shutter lever 222 may be disposed at the same position on each lever. Specifically, referring to FIG. 7A, the rotation axis pins 230 of the upper shutter lever 221 and the lower shutter lever 222 may be disposed at the same position on the two shutter levers 220, that is, without being biased to a front surface or a rear surface.

As the rotation axis pins 230 of the upper shutter lever 221 and the lower shutter lever 222 are formed at the same position on each lever, that is, the rotation axis pins 230 of the upper shutter lever 221 and the lower shutter lever 222 are disposed up and down on the same line, the upper shutter lever 221 and the lower shutter lever 222 can be easily rotated by one connection link 240.

### <Connection Link 240>

The connection link 240 connects the plurality of shutter levers 220 and is movable so that the shutter levers 220 rotate.

Specifically, the connection link 240 may include an upper connection link 241 connecting the upper shutter lever 221 and the lower shutter lever 222, and a lower connection link 242 connecting the lower shutter lever 222 and the main link 260.

Specifically, the upper connection link 241 connects the upper shutter lever 221 and the lower shutter lever 222. And, the lower connection link 242 may connect the lower shutter lever 222 and the main link 260.

At this time, the lower connection link 242 may be connected to the lower shutter lever 222 at a position where the upper connection link 241 is connected to the lower shutter lever 222. That is, the upper connection link 241 and the lower connection link 242 may be connected at the same point of the lower shutter lever 222.

The connection links 240 may be connected by joint pins 250 that are rotatably coupled to each other.

Specifically, the joint pins 250 may include a first joint pin 251 connecting one end of the upper connection link 241 and the upper shutter lever 221, a second joint pin 252 connecting another end of the upper connection link 241, one end of the lower connection link 242, and the lower shutter lever 222, and a third joint pin 253 connecting another end of the lower connection link 242 and another end portion 262 of the main link. However, unlike the above description, more joint pins 250 may be provided.

The upper connection link 241 and the lower connection link 242 may be connected to the upper shutter lever 221 and the lower shutter lever 222 at positions farthest away from the rotation axis pins 230 in remaining regions, except for regions connected to the shutter plate 210.

First, referring to FIG. 7A, a region 2201 where the upper shutter lever 221 and the lower shutter lever 222 are connected to the shutter plate 210 is a section where the shutter lever 220 is connected to the shutter plate 210 from the inside of the first groove formed in the shutter lever 220.

Also, referring to FIG. 7A, a remaining region 2202 excluding the region connected to the shutter plate 210 is a region where the upper shutter lever 221 and the lower shutter lever 222 are connected to the shutter plate 210.

At this time, each of the upper connection link 241 and the lower connection link 242 may each be connected to a position farthest away from the rotation axis pin 230 in the remaining region 2202 excluding the region connected to the shutter plate 210.

According to one embodiment of the present disclosure, as the upper connection link 241 and the lower connection link 242 are connected to the farthest positions from the rotation axis pin 230 in the remaining region 2202 except for the region connected to the shutter plate 210 of each shutter lever 220, a moment (rotational force) that is transferred to the shutter lever 220 when the connection link 240 moves can be increased. Accordingly, the shutter lever 220 can be easily rotated by the connection link 240.

Also, referring to FIG. 7A, the upper connection link 241 is connected to the upper shutter lever 221 at a side far away from the shutter plate 210 based on the rotation axis pin 230.

In addition, the lower connection link 242 is connected to the lower shutter lever 222 at a side close to the shutter plate 210 based on the rotation axis pin 230.

According to one embodiment of the present disclosure, the upper connection link 241 is connected to the upper shutter lever 221 at the side far away from the shutter plate 210 based on the rotation axis pin 230, and the lower connection link 242 is connected to the lower shutter lever 222 at the side close to the shutter plate 210 based on the rotation axis pin 230. Accordingly, when the lower connection link 242 moves downward, the lower connection link 242 and the upper connection link 241 move so as to rotate the upper shutter plate 211 and the lower shutter plate 212 in different directions.

### <Main Link 260>

The main link 260 may be connected to the connection link 240 to move the connection link 240 downward when the circuit breaker 150 is inserted. However, the connection link 240 may be moved downward using a configuration other than the main link 260. As described above, when the lower connection link 242 is moved downward, the lower connection link 242 and the upper connection link 242 may be moved and rotated, which may result in rotating the upper shutter plate 211 and the lower shutter plate 212 in different directions.

The main link 260 may be disposed on a path along which the circuit breaker 150 is introduced (inserted, drawn) into the switchboard 1000. As the circuit breaker 150 is introduced, at least a portion of the main link 260 may be pressed to be rotated centering on one axis.

According to one embodiment, the main link 260 may be disposed on a path along which the circuit breaker 150 is introduced into the switchboard 1000. As the circuit breaker 150 is introduced, the main link 260 may be pressed by a wheel disposed on a lower portion of the circuit breaker 150 so as to be rotated centering on one axis.

Specifically, referring to FIGS. 7A and 7B, as the circuit breaker 150 approaches the shutter plate 210, the main link 260 may be rotated centering on a rotation axis groove 261a disposed in one end portion 261 of the main link 260. As the main link 260 is rotated, the connection link 240 may be moved downward and rotated at the same time.

The main link 260 may include a stopping jaw 263 by which the circuit breaker wheel 158 is caught. At this time, the main link 260 may be rotatable when the circuit breaker wheel 158 enters more inward than the stopping jaw 263.

Specifically, referring to FIG. 7A, when the circuit breaker 150 is located at the test position (in the second state), it is disposed at the front of the stopping jaw 263 of the main link 260. At this time, the circuit breaker wheel 158 does not rotate the main link 260. The shutter assembly 200 may not be rotated.

Referring to FIG. 7B, in the process of moving the circuit breaker 150 from the test position (second state) to the connected position (third state), the circuit breaker wheel 158 may enter more inward than the stopping jaw 263. At this time, the main link 260 may be rotated centering on the rotation axis groove 261a as described above. A pin for rotation may be inserted into the rotation axis groove 261a.

On the other hand, a stopping groove 264 may be formed in the main link 260 to limit a rotation range when the main link 260 rotates. Specifically, the rotation range of the main link 260 may be limited as a protrusion formed on the switchboard case 100 is locked in the stopping groove 264 during the rotation of the main link 260. This may suppress the main link 260 from rotating over such a limited region.

As another embodiment, the main link 260 may be disposed on a path through which the circuit breaker 150 is introduced into the switchboard 1000. As the circuit breaker 150 is introduced, the main link 260 may be pressed by a pressing plate 157 disposed on a circuit breaker lower body 153 so as to be rotated centering on one axis.

The pressing plate 157 disposed on the circuit breaker lower body 153 may be disposed on the circuit breaker 150 in a direction protruding through the drawing. Specifically, the main link 260 may be disposed to protrude more outward that the wheel 158 of the circuit breaker 150. Accordingly, the pressing plate 157 may be disposed to protrude outside the circuit breaker 150 in order to be in contact with a second line 268 of the main link 260.

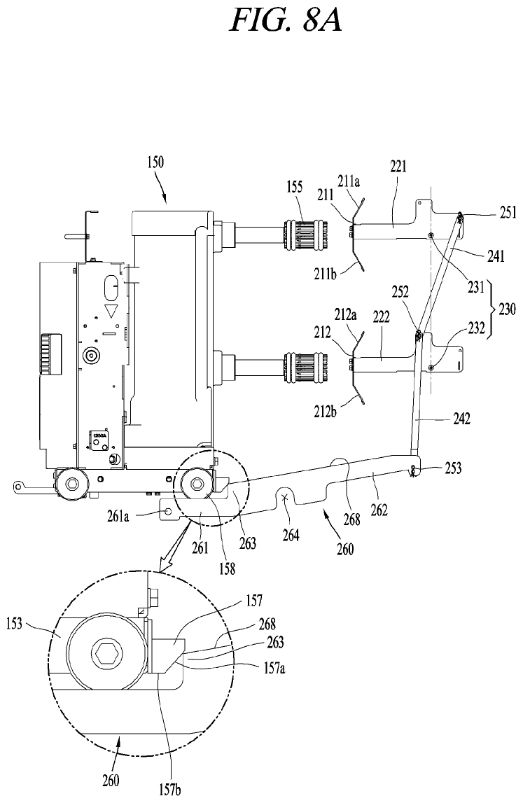

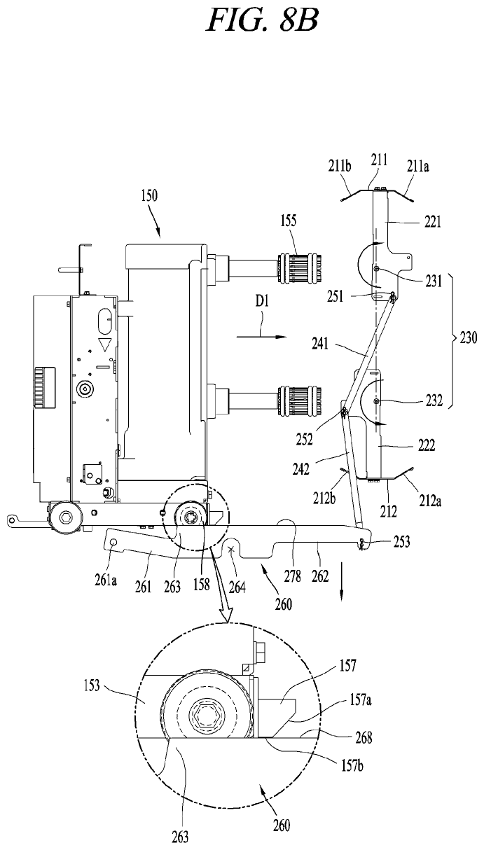

Referring to FIGS. 8A and 8B, as the circuit breaker 150 approaches the shutter plate 210, the main link 260 may be rotated centering on the rotation axis groove 261a disposed in the one end portion 261 of the main link 260. As the main link 260 is rotated, the connection link 240 may be moved downward and rotated at the same time.

The main link 260 may include a first line 267 that is disposed more forward than the stopping jaw 263 and is a relatively low surface, and a second line 268 extending to a rear surface of the stopping jaw 263 and is a relatively high surface.

At this time, the second line 268 of the main link 260 may be pressed by the pressing plate 157 disposed on the circuit breaker lower body 153.

Specifically, referring to FIG. 8A, the stopping jaw 263 is locked by an inclined surface 157a of the pressing plate 157. The stopping jaw 263 is pressed downward while moving along the inclined surface 157a. Accordingly, the main link 260 can be rotated centering on the rotation axis groove 261a.

Referring to FIG. 8B, while the circuit breaker 150 moves from the test position (second state) to the connected position (third state), a lower surface 157b of the pressing plate 157 presses the second line 268 of the main link 260. Accordingly, the main link 260 can be maintained in a rotated state.

Meanwhile, unlike in the above-described embodiment, the pressing plate 157 may be configured in another shape, by which the main link 260 can be rotated centering on the rotation axis groove 261a by at least a portion of the circuit breaker 150 as the circuit breaker 150 proceeds from the second state to the third state. For example, a rotation structure may be installed on the circuit breaker lower body 153 to be rotatable in response to the movement of the circuit breaker 150, so as to rotate the circuit breaker as the circuit breaker 150 moves inward.

### <Operation of Shutter Assembly 200>

Hereinafter, an operation of the shutter assembly 200 will be described with reference to the above-described configuration.

When the circuit breaker 150 is located at the disconnected position (in the first state) or the test position (in the second state), the main link 260 does not rotate. And, the shutter plate 210 of the shutter assembly 200 is disposed to block the external terminal 110.

And, referring to FIGS. 7A and 7B, while the circuit breaker 150 moves to the connected position (third state), the circuit breaker wheel 158 enters while pressing the stopping jaw 263 of the main link 260 downward. Accordingly, the main link 260 can be rotated centering on one axis.

Accordingly, the connection link 240 connected to the main link 260 may be moved downward. Since the lower connection link 242 and the upper connection link 241 are connected, the lower connection link 242 and the upper connection link 241 may be moved downward while being rotated counterclockwise based on the drawing.

Responsive to this, the upper shutter lever 221 is rotated upward and the lower shutter lever 222 is rotated downward. Then, the upper shutter plate 211 connected to the upper shutter lever 221 and the lower shutter plate 212 connected to the lower shutter lever 222 are rotated upward and downward, respectively.

And, referring to FIGS. 5 and 7A, when the circuit breaker 150 moves from the third state back to the second state and the first state, the lower shutter lever 222 which has been moved to open the external terminal 110 may be rotated again to close the external terminal 110 by the elastic member 270 connected to the lower shutter lever 222.

According to the shutter assembly 200 and the switchboard 1000 according to one embodiment of the present disclosure, as the circuit breaker 150 enters the switchboard case 100, the circuit breaker main body 151 may press the shutter assembly 200. Accordingly, the shutter assembly 200 can close or open the external terminal 110.

In addition, according to the shutter assembly 200 and the switchboard 1000 according to one embodiment of the present disclosure, the upper shutter plate 211 may be rotated to face upward, and the lower shutter plate 212 may be rotated to face downward. Accordingly, spaces defined above and below the external terminal 110 can be efficiently utilized.

### 4. Locking Device 400

The locking device 400 according to one embodiment of the present disclosure is disposed inside the switchboard 1000 and is configured to lock or unlock the shutter assembly 200 that opens and closes the terminal of the external terminal 110.

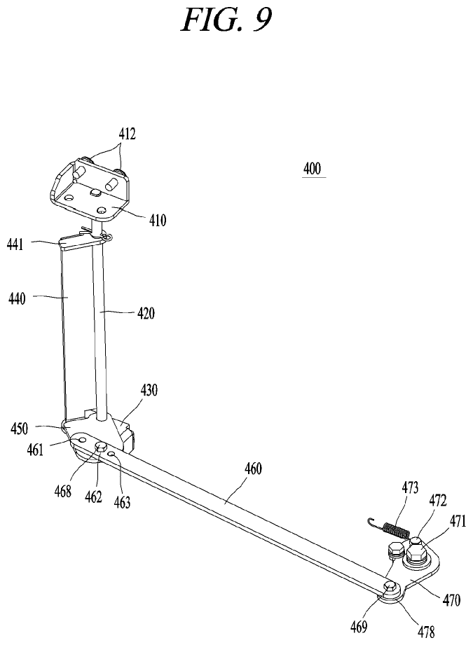

Specifically, referring to FIG. 9, the locking device 400 may include a rotation part, a shutter locking plate 440, a connecting rotation plate 470, and a connecting rod 460.

The rotation part 410, 420, 430, 450 is disposed adjacent to the shutter plate 210 of the shutter assembly 200 and is configured to be rotatable. The rotation part may lock or unlock the shutter plate 210 through rotation.

The rotation part may include a fixed plate 410, a lower plate 430, a rotation rod 420, and a rotation part plate 450.

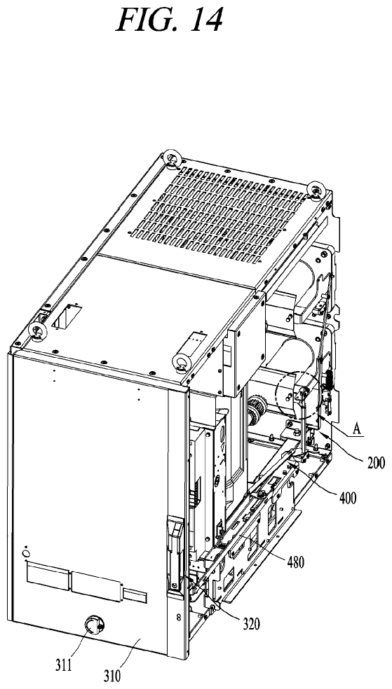

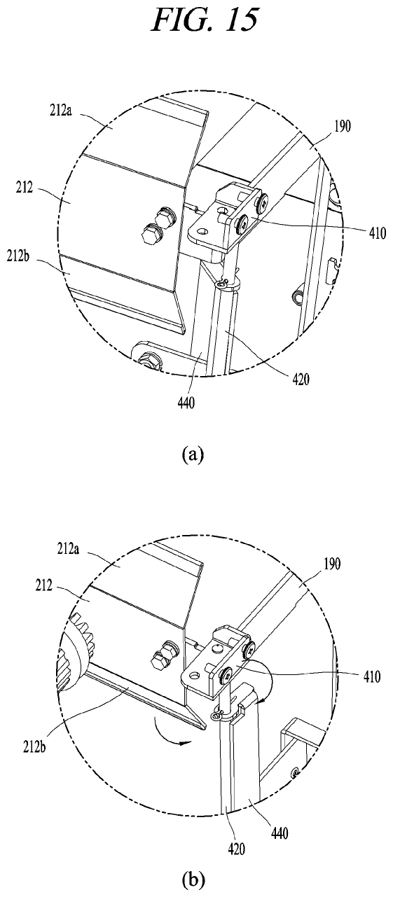

Specifically, referring to FIG. 15, the fixing plate 410 may be fixed to a fixing part 190 inside the switchboard 1000, disposed adjacent to the shutter plate 210, using a coupling member 412.

Next, referring to FIG. 9, the lower plate 430 may be disposed adjacent to a lower surface of the switchboard case 100 corresponding to the fixed plate 410. Specifically, the lower plate 430 is disposed at a lower portion corresponding to the fixed plate 410. The fixed plate 410 may be fixedly disposed on the lower surface of the switchboard case 100.

One side of the rotation rod 420 may be coupled to the fixed plate 410, and another side may be coupled to the lower plate 430 to be rotatable.

The rotation part plate 450 may be coupled to be rotatable relative to the lower plate 430 and may be rotatable as the rotation rod 420 is rotated. The rotation part plate 450 may be rotated relative to the lower plate 430 by the connecting rod 460, which will be described later. As the rotation part plate 450 is rotated, a shutter locking plate 440 may be rotated.

The shutter locking plate 440 is coupled to the rotation part and rotated together with the rotation part. Specifically, when the circuit breaker main body 151 presses the connecting rotation plate 470, the connecting rotation plate 470 is rotated.

Accordingly, the rotation part plate 450 connected to the connecting rotation plate 470 by the connecting rod 460 is rotated. And, the shutter locking plate 440 connected to the rotation part plate 450 may be rotated.

The connecting rotation plate 470 is disposed to be spaced apart from the rotation part, and is pressed and rotated by the circuit breaker main body 151 during the process that the circuit breaker 150 is inserted into the switchboard 1000.

At this time, the connecting rotation plate 470 is rotated centering on the rotation axis pin 471. And, the connecting rotation plate 470 may be coupled to the door locking rod 480 through a coupling bolt 472. A pressing region 478 where the connecting rotation plate 470 is pressed by the circuit breaker main body 151 may be an edge portion connected to the connecting rod 460. Additionally, the rotated connecting rotation plate 470 may be rotated back to its original position by the elastic member 473 when the circuit breaker 150 is removed.

The connecting rotation plate 470 may be pressed by the circuit breaker main body 151 in the process of switching from the second state to the third state. And, the connecting rod 460 is coupled to each of the rotation part and the connecting rotation plate 470, and transmits rotational force generated by a second rotation plate to a first rotation plate.

One side of the connecting rod 460 is connected to the rotation part plate 450 through a first coupling member 468, and another side is connected to the connecting rotation plate 470 through a second coupling member 469. The connecting rod 460 may be configured to transmit driving force to the rotation part plate 450, such that the rotation part plate 450 rotates in response to the rotation of the connecting rotation plate 470.

### <Movement of Shutter Locking Plate 440>

Hereinafter, the movement of the shutter locking plate 440 will be described.

The shutter locking plate 440 is disposed in an area (region), in which it can lock (block) the shutter plate 210, before the connecting rotation plate 470 is rotated by the circuit breaker 150.

Meanwhile, the shutter locking plate 440 may have a shutter locking plate head 441, which has an area larger than that of the shutter locking plate 440. The shutter locking plate head 441 may reduce an impact transmitted by rotation of the shutter plate 210.

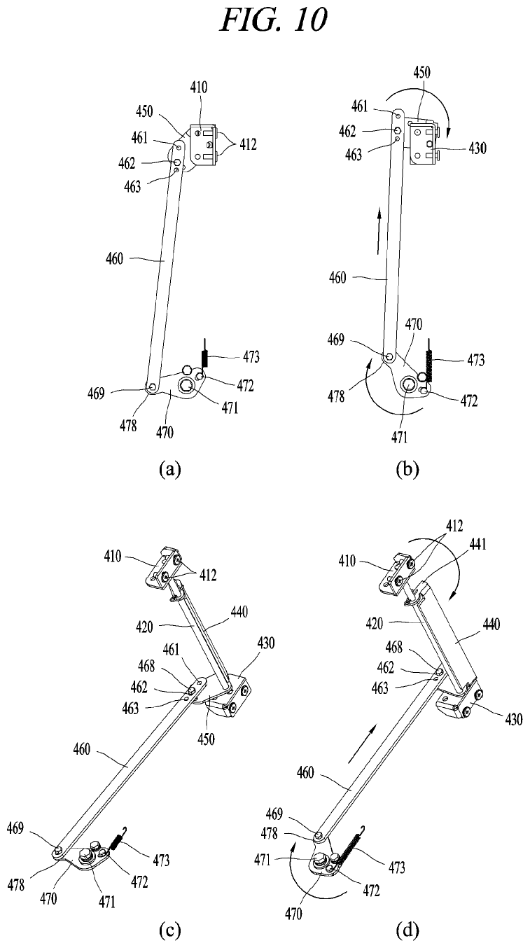

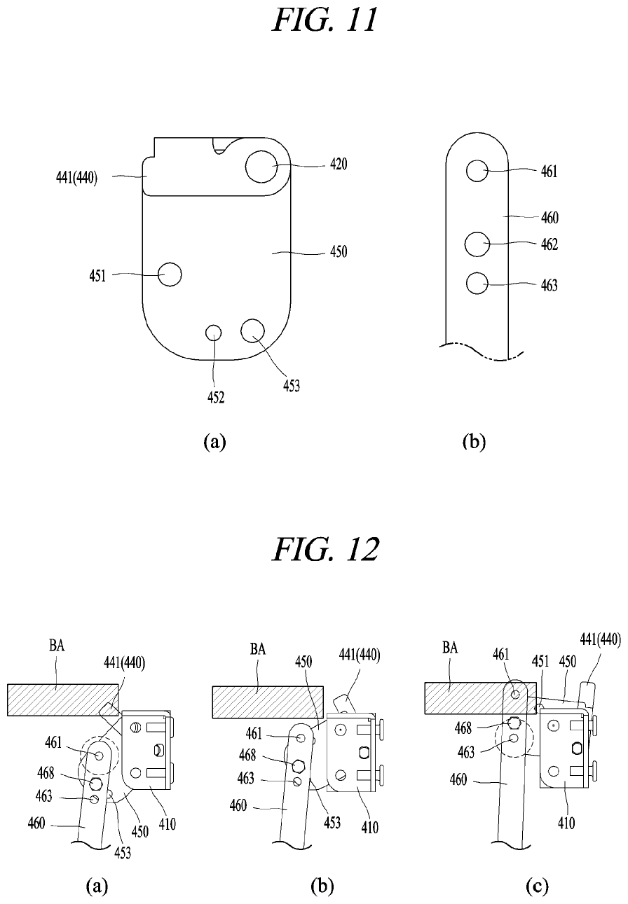

Specifically, referring to (a) of FIG. 12 and FIG. 15, in a state before rotation, the shutter locking plate 440 is disposed in a blocking area (BA), in which it locks (blocks) the shutter plate 210 when the shutter plate 210 rotates. Accordingly, when the shutter plate 210 rotates, it is locked by the shutter locking plate 440 and thereby is not rotated. That is, the shutter locking plate 440 can restrict the rotation of the shutter plate 210 in the area before rotation.

The shutter locking plate 440 may be rotated to the outside of the blocking area of the shutter plate 210 when the circuit breaker 150 is inserted into the switchboard 1000 and the connecting rotation plate 470 is rotated by the circuit breaker 150.

Referring to (a), (b), and (c) of FIG. 12, (a) of FIG. 12 illustrates the state before the shutter locking plate 440 is rotated, and (b) of FIG. 12 illustrates a state during the rotation of the shutter locking plate 440. And, (c) of FIG. 12 illustrates a state after the shutter locking plate 440 is completely rotated.

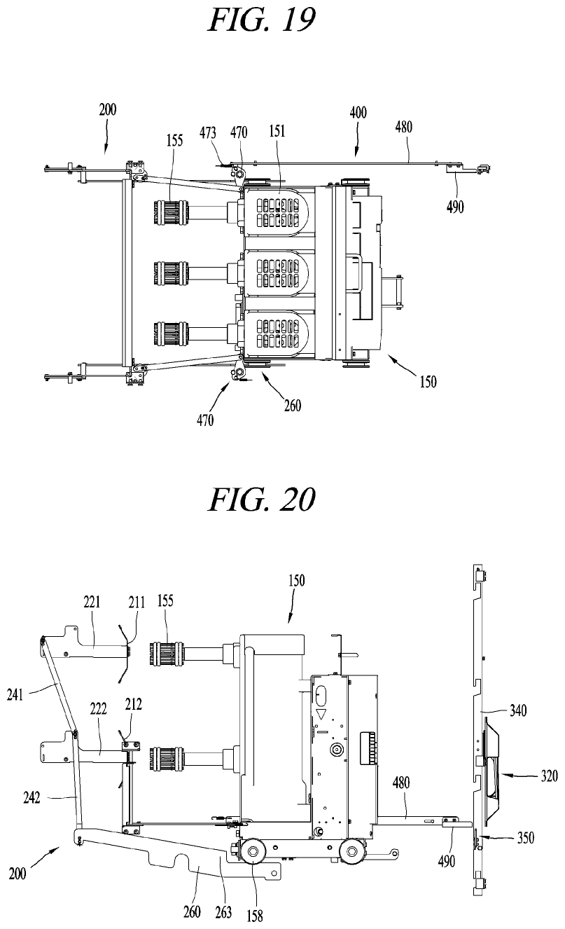

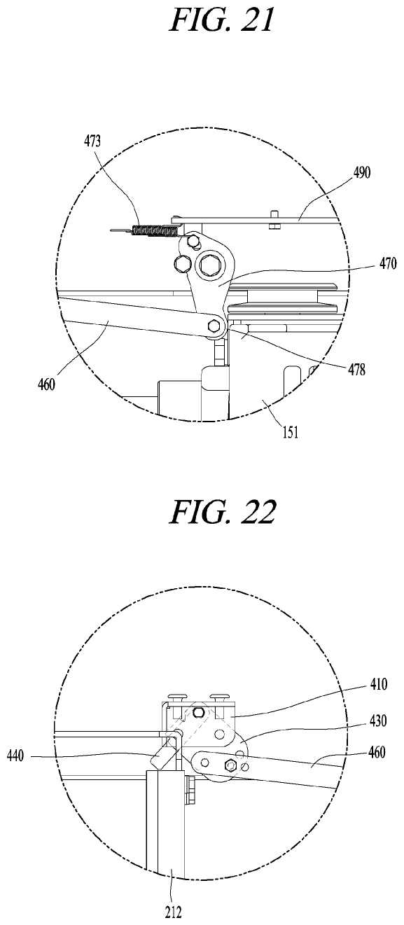

Referring to FIGS. 19 to 23, it is illustrated that the circuit breaker 150 is in the second state inside the switchboard case 100. Alternatively, it is an initial state in which the circuit breaker 150 is moved from the second state to the third state inside the switchboard case 100. In this case, the circuit breaker 150 does not press the connecting rotation plate 470. Therefore, the rotation part of the locking device 400 does not rotate.

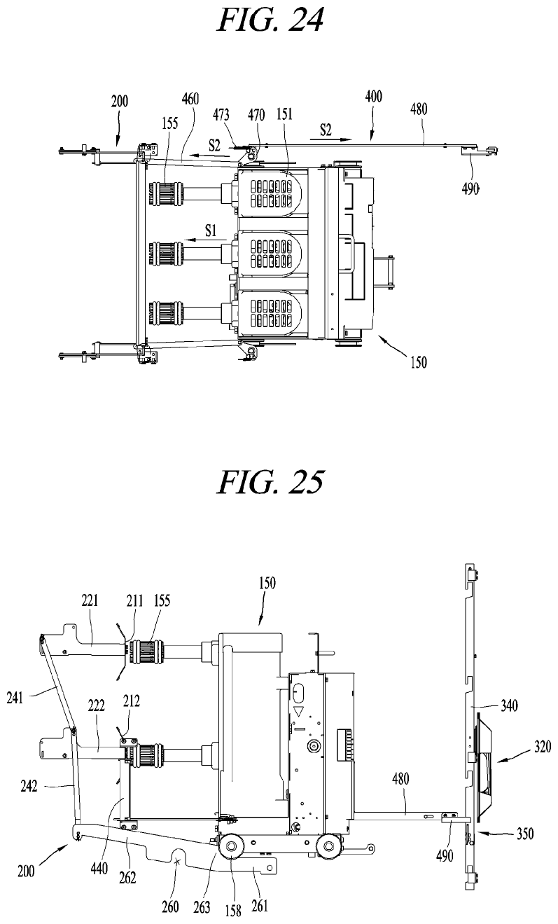

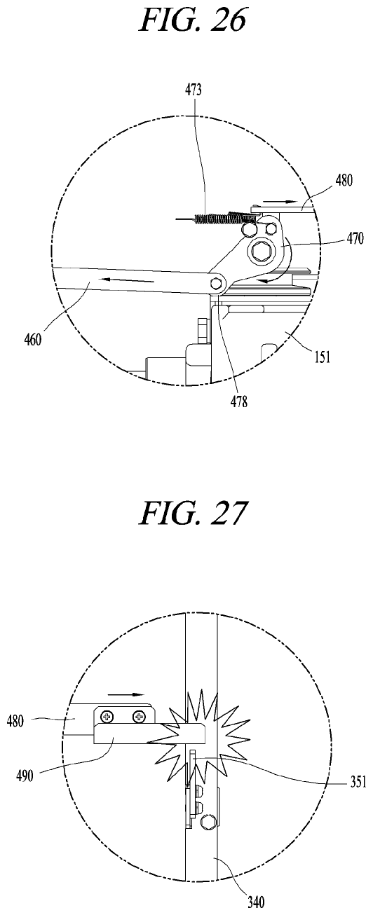

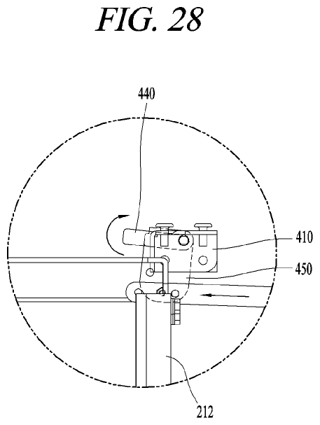

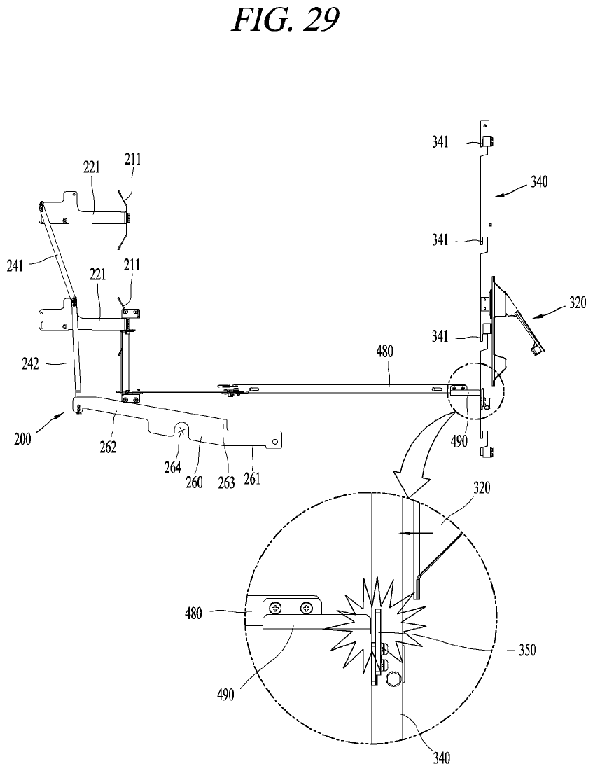

Referring to FIGS. 24 to 29, it is illustrated that the circuit breaker 150 is being moved (switched) from the second state to the third state within the switchboard case 100. In this case, the circuit breaker 150 presses the connecting rotation plate 470.

As the connecting rotation plate 470 is pressed, the connecting rod 460 is moved in a direction toward the shutter plate 210. Accordingly, the rotation part plate 450 connected to the connecting rod 460 is rotated. Then, the shutter locking plate 440 coupled to the rotation part plate 450 is rotated.

Referring to (b) and (c) of FIG. 12, as the rotation part plate 450 is rotated, the shutter locking plate 440 is moved to the outside of the blocking area BA where it can block (lock) the shutter plate 210 when the shutter plate 210 rotates. Accordingly, the shutter plate 210 is switched to an unlocked state in which it can rotate freely. That is, the locking device 400 unlocks the rotation of the shutter plate 210.

### <Fixing Function of Connecting Rod 460 and Rotation Part Plate 450>

Meanwhile, the connecting rod 460 may include a first groove 461, a second groove 462, and a third groove 463 that are formed in a line in one end portion thereof connected to the rotation part plate 450 and spaced apart from one another.

In addition, the rotation part plate 450 may include a first hole 451 disposed at a position corresponding to the first groove 461 as the rotation part plate 450 is rotated in one direction, a second hole 452 connected to the second groove 462 through a rotation pin so as to be a center of a rotational axis, and a third hole 453 disposed at a position corresponding to the third groove 463 as the rotation part plate 450 is rotated in another direction.

At this time, when a locking pin is inserted into the first groove 461 and the first hole 451 at a position where the first groove 461 of the connecting rod 460 and the first hole 451 of the rotation part plate 450 are aligned with each other (correspond to each other), the shutter locking plate 440 may be fixedly disposed within a radius in which the shutter plate 210 rotates.

Specifically, referring to (a) of FIG. 12, the first groove 461 of the connecting rod 460 and the first hole 451 of the rotation part plate 450 are disposed at the position where they are aligned with each other.

In this case, the first groove 461 of the connecting rod 460 and the first hole 451 of the rotation part plate 450 are disposed at the position where they communicate with each other. At this time, the locking pin may be inserted through the first groove 461 of the connecting rod 460 and the first hole 451 of the rotation part plate 450.

When the locking pin (not shown) is inserted through the first groove 461 of the connecting rod 460 and the first hole 451 of the rotation part plate 450, the shutter locking plate 440 may be fixedly disposed in the blocking area BA. Accordingly, the rotation of the shutter plate 210 is restricted.

For example, in a situation where the shutter plate 210 must block the external terminal 110, the shutter plate 210 should not open the external terminal 110. Therefore, as aforementioned, the shutter locking plate 440 may be fixed by inserting the locking pin through the first groove 461 of the connecting rod 460 and the first hole 451 of the rotation part plate 450. This case may be referred to as fixing of the shutter assembly 200 in a locked state through the locking device 400.

When the locking pin is inserted into the third groove 463 and the third hole 453 at a position where the third groove 463 of the connecting rod 460 and the third hole 453 of the rotation part plate 450 are aligned with each other (correspond to each other), the shutter locking plate 440 may be fixedly disposed outside the radius in which the shutter plate 210 rotates.

Specifically, referring to (c) of FIG. 12, the third groove 463 of the connecting rod 460 and the third hole 453 of the rotation part plate 450 are disposed at the position where they are aligned with each other.

In this case, the third groove 463 of the connecting rod 460 and the third hole 453 of the rotation part plate 450 are disposed at the position where they communicate with each other. At this time, the locking pin may be inserted through the third groove 463 of the connecting rod 460 and the third hole 453 of the rotation part plate 450.

When the locking pin is inserted through the third groove 463 of the connecting rod 460 and the third hole 453 of the rotation part plate 450, the shutter locking plate 440 may be fixedly disposed in an area out of the blocking area BA. Accordingly, the restriction of the rotation of the shutter plate 210 is released. That is, the shutter plate 210 can be freely rotated.

For example, in a situation where the shutter plate 210 is needed to open the external terminal 110, the shutter locking plate 440 may be fixed by inserting the locking pin through the third groove 463 of the connecting rod 460 and the third hole 453 of the rotation part plate 450. This case may be referred to as fixing of the shutter assembly 200 in an unlocked state through the locking device 400.

According to one embodiment of the present disclosure, as the locking pin is inserted at the position where the groove and the hole of the connecting rod 460 and the rotation part plate 450 communicate with each other, the locking device 400 can fix the shutter assembly 200 in the locked state or in the unlocked state.

Accordingly, the locked state and the unlocked state of the rotation of the shutter plate 210 can be freely fixed by the operation of inserting the locking pin at the position where the grove and the hole formed in the connecting rod 460 and the rotation part plate 450, respectively, communicate with each other. This can provide an advantage of easily fixing the shutter plate 210 in the locked state or the unlocked state to be appropriate for a situation during maintenance and repair of the switchboard 1000.

### 5. Shutter Assembly 200 and Locking Device 400 within Switchboard 1000

In the switchboard 1000 according to one embodiment of the present disclosure, the main link 260 of the shutter assembly 200 may be disposed closer to the circuit breaker 150 than the connecting rotation plate 470 of the locking device 400.

Specifically, referring to FIG. 19, the main link 260 of the shutter assembly 200 is disposed closer to the circuit breaker 150 than the connecting rotation plate 470 of the locking device 400. Specifically, the main link 260 is disposed closer to the circuit breaker 150 than the rotation axis of the connecting rotation part plate 470.

The circuit breaker wheel 158 is rolled on the main link 260 of the shutter assembly 200. Accordingly, the main link 260 is disposed closer to the circuit breaker 150 than the connecting rotation plate 470 of the locking device 400.

Additionally, in the switchboard 1000 according to one embodiment of the present disclosure, the main link 260 may include a stopping jaw 263 by which the wheel of the circuit breaker 150 is caught (locked, blocked). And, the stopping jaw 263 of the main link 260 is configured to be rotated when the circuit breaker wheel 158 enters more inward than the stopping jaw 263.

After the connecting rotation plate 470 is rotated, that is, after the locking device 400 unlocks the rotation of the shutter assembly 200, the main link 260 can be rotated. That is, the shutter assembly 200 can be rotated.

That is, the connecting rotation plate 470 and the main link 260 may be disposed to be rotatable inside the switchboard 1000.

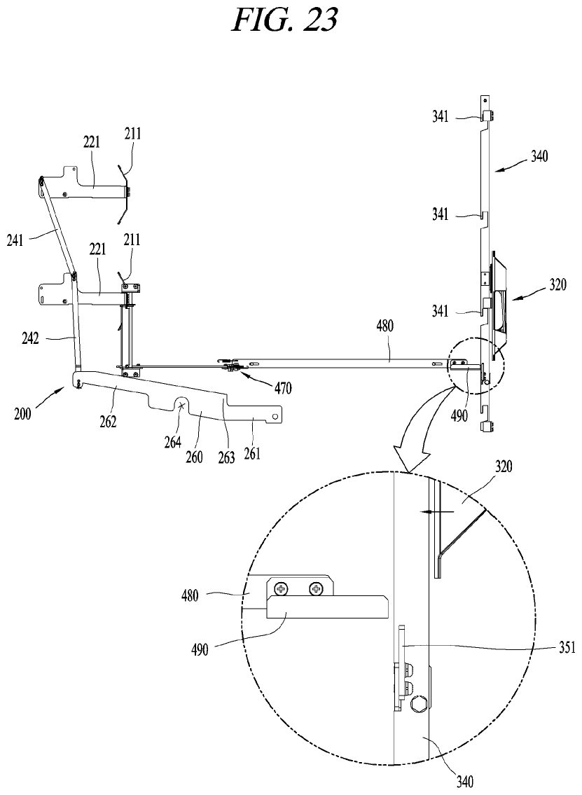

Referring to FIG. 23, the stopping jaw 263 of the main link 260 of the shutter assembly 200 may be disposed closer to the rear surface of the switchboard case 100 than the connecting rotation plate 470 of the locking device 400.

Through the structure, the circuit breaker 150 first presses the connecting rotation plate 470 while moving from the second state to the third state. Through this, as the connecting rotation plate 470 is rotated, i) first, the shutter locking plate 440 disposed below the shutter plate 210 is moved. Accordingly, the rotation of the shutter plate 210 can be unlocked.

ii) Next, as the connecting rotation plate 470 is rotated, the door locking rod 480 and the door locking plate 490 described above may be moved toward the door 300. Accordingly, the door 300 can be locked from being open arbitrarily.

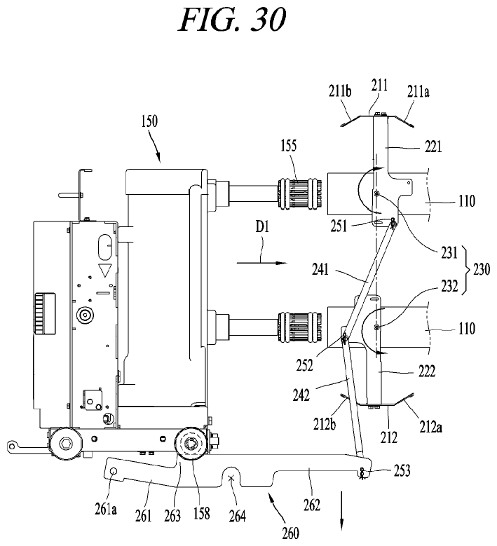

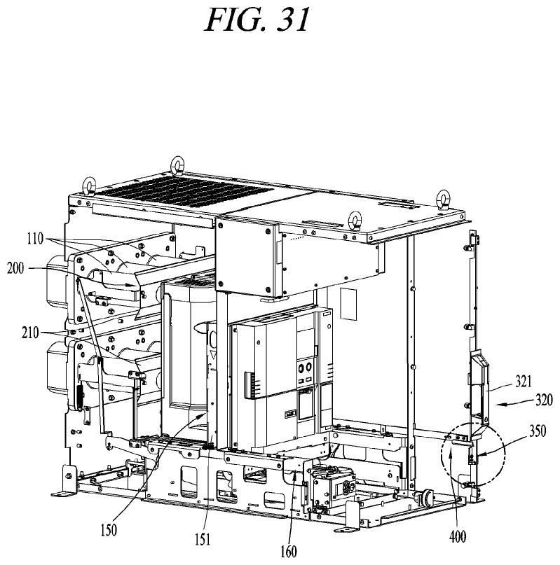

Next, referring to FIG. 30, the circuit breaker 150 may rotate the shutter plate 210 beyond the stopping jaw 263 of the main link 260.

In the switchboard 1000 according to one embodiment of the present disclosure, since the stopping jaw 263 of the main link 260 is disposed closer to the rear surface of the switchboard case 100 than the connecting rotation plate 470, the shutter assembly 200 can be rotated after the locking device 400 unlocks the rotation of the shutter assembly 200. Through this, the locking device 400 can first release the locked state of the shutter assembly 200, and the shutter assembly 200 can unlock the external terminal 110.

That is, while the circuit breaker 150 moves to be connected to the external terminal 110, the locking device 400 may unlock the shutter assembly 200 and the shutter assembly 200 may unlock the external terminal 110 in a sequential manner. Through this, the circuit breaker 150 can be connected to the external terminal 110 more safely inside the switchboard 1000.

### 6. Description of Door Interlock Plate Portion, Door Locking Rod and Operations Thereof

### <Door Interlock Plate Portion 350>

The door sliding plate 340 may further include a door interlock plate portion 350 that is disposed to cover (close) or not to cover the door locking plate insertion groove 311a as the door sliding plate 340 moves up and down.

The door interlock plate portion 350 may include a door interlock plate 351, a connection plate 352, and a coupling member 353.

The door interlock plate 351 is coupled to the door sliding plate 340. Accordingly, the door interlock plate 351 can be moved in the direction in which the door sliding plate 340 is moved.

The door interlock plate 351 may have an approximately rectangular shape that is long vertically. However, it is not limited to this, and a plane that can open and close the door locking plate insertion groove 311a may be formed in various shapes such as square, triangle, or pentagon.

The connection plate 352 is a connection member for coupling the door interlock plate 351 and the door sliding plate 340 to each other. One end of the connection plate 352 is coupled to the door sliding plate 340 so as to move together as the door sliding plate 340 moves up and down.

The door sliding plate 340 may have a plate shape with a long surface in one direction. Additionally, a door cover edge portion 311 may have a plate shape with a long surface in a direction perpendicular to the direction in which the door sliding plate 340 has the long surface.

Accordingly, the door interlock plate 351, which has the approximate square plate shape, must be disposed, such that the long surface (i.e., major plane) thereof faces the door locking plate insertion groove 311a. The door interlock plate 351 thus closes (covers) the door locking plate insertion groove 311a formed in the door cover edge portion 311.

Accordingly, the connection plate 352 may be a plate having two surfaces bent at an angle of 90 degrees. However, the connection plate 352 is not limited to this shape, and may alternatively be bent by less than 90 degrees or by 90 degrees or more depending on its design.

The coupling member 353 may be provided in plurality. Some of the coupling members 353 connect the door sliding plate 340 and the connection plate 352. And, the other coupling members 353 connect the connection plate 352 and the door interlock plate 351. Through this, the door sliding plate 340, the connection plate 352, and the door interlock plate 351 can be integrally moved.

The door sliding plate 340 may be moved upward as the door handle portion 320 is open and may be moved downward as the door handle portion 320 is closed.

Specifically, when the door sliding plate 340 is moved downward, the door interlock plate 351 is moved downward so that the door locking plate insertion groove 311a is open. This can be said that the door interlock plate 351 is disposed at a first position of opening the door locking plate insertion groove 311a.

And, when the door sliding plate 340 is moved upward, the door interlock plate 351 is moved upward to be disposed at a second position where it closes the door locking plate insertion groove 311a.

That is, when the door sliding plate 340 is moved upward, the door interlock plate 351 is moved upward so that the door locking plate insertion groove 311a is closed. And, when the door sliding plate 340 is moved downward, the door interlock plate 351 is moved downward so that the door locking plate insertion groove 311a is open.

The door sliding plate 340 may be moved upward as the door handle portion 320 is open and may be moved downward as the door handle portion 320 is closed.

Specifically, when the door sliding plate 340 is moved downward, the door interlock plate 351 is moved downward so that the door locking plate insertion groove 311a is open. This can be said that the door interlock plate 351 is disposed at the first position of opening the door locking plate insertion groove 311a.

And, when the door sliding plate 340 is moved upward, the door interlock plate 351 is moved upward to be disposed at the second position of closing the door locking plate insertion groove 311a.

### <Operation of Door 300—Opening and Closing of Door Locking Plate 490 and Door 300>

In the open state of the door handle portion 320, the door interlock plate 351 is disposed to close the door locking plate insertion groove 311a. On the other hand, in the closed state of the door handle portion 320, the door interlock plate 351 is disposed to open the door locking plate insertion groove 311a.

At this time, when the door locking plate insertion groove 311a is disposed to be closed by the door interlock plate 351, the door locking plate 490 cannot be inserted into the door locking plate insertion groove 311a.

That is, when the door handle portion 320 is open, the door locking plate 490 cannot be inserted into the door locking plate insertion groove 311a.

Conversely, when the door locking plate is inserted into the door locking plate insertion groove, the door interlock plate cannot be moved upward. Specifically, in the course that the door interlock plate is moved upward, the door interlock plate is blocked by the door locking plate inserted into the door locking plate insertion groove, so the door interlock plate cannot be moved upward.

In other words, in order for the door interlock plate to be moved upward, the door handle portion must be switched from the closed state to the open state. When the door locking plate is inserted into the door locking plate insertion groove, the door handle portion for opening the door cover from the switchboard cannot be switched from the closed state to the open state.

### <Door Locking Rod 480>

The locking device 400 may further include a door locking rod 480 that has one end connected to the connecting rotation plate 470.

Specifically, referring to FIGS. 13 and 19 to 29, the door locking rod 480 may be coupled to a portion opposite to a portion where the connecting rod 460 is coupled to the connecting rotation plate 470.

The door locking rod 480 may have a connecting portion 481 that protrudes from one end thereof to one side to be coupled to the connecting rotation plate 470. The door locking rod 480 may further include a door locking plate 490 disposed on another end thereof.

A guide bolt 483 and a guide bolt hole 482 that guide the door locking rod 480 during the movement of the door locking rod 480 may be disposed in a body of the door locking rod 480.

Meanwhile, an elastic member 484 may be disposed on one end of the door locking rod 480. After the door locking rod 480 is moved, when pressing force that caused the movement is eliminated, the door locking rod 480 may return to its original position by the elastic member 484.

Additionally, the door locking rod 480 may be moved in an opposite direction to the connecting rod 460 when the connecting rotation plate 470 is rotated.

Referring to FIG. 13, the locking device 400 may further include the door locking plate 490 that is coupled to another end of the door locking rod 480 and extends in a direction parallel to a lengthwise direction of the door lock rod 480.

The door locking plate 490 may include a first body 491 connected to the door locking rod 480 by the coupling member 493, and a second body 492 extending from the first body 491 in the shape of “L”. However, the door locking plate 490 is not limited to being divided into the first body 491 and the second body 492 described above, and may alternatively be formed integrally or in another shape.

As the connecting rotation plate 470 rotates, the door locking plate 490 may be moved in the lengthwise direction of the door locking rod 480 so as to be inserted into the door locking plate insertion groove 311a formed in the door 300.

Specifically, referring to FIGS. 24 to 29, the door locking plate 490 may be moved in the lengthwise direction of the door locking rod 480 when the connecting rotation plate 470 is rotated by the circuit breaker main body 151. That is, the door locking rod 480 may be moved in a direction toward the switchboard door 300.

When the door locking rod 480 moves in the direction toward the switchboard door 300, the another end of the door locking rod 480 may penetrate through at least a portion of the switchboard door 300.

Specifically, referring to FIG. 5 and the like, the door locking plate 490 may be pulled out of the switchboard case 100 through the switchboard case groove 103a formed in a front edge 103 of the switchboard case 100.

And, referring to FIG. 17, the door locking plate 490 pulled out through the switchboard case groove 103a may protrude toward the door cover 310 along the door locking plate insertion groove 311a formed in the door cover edge portion 311.

Specifically, the door locking rod 480 may be configured to be inserted through the door locking plate insertion groove 311a while the circuit breaker 150 is switched from the second state to the third state.

Referring to FIGS. 25 and 27, when the door locking rod 480 is disposed in a state that it has passed through the door locking plate insertion groove 311a, the door interlock plate 351 is restricted from moving from the first position to the second position by the door locking rod 480 pulled out of the door locking plate insertion groove 311a. That is, when the door locking plate 490 protrudes toward the door cover 310, the door handle 321 of the door handle portion 320 cannot be open.

Specifically, when the door handle 321 is open as described above, the door interlock plate 351 is moved upward. However, referring to FIG. 27, since the door locking plate 490 protrudes toward the door cover 310, the door interlock plate 351 that is supposed to be moved upward is restricted by the door locking plate 490. Therefore, the door locking rod 480 can suppress the door 300 from being arbitrarily open when the circuit breaker 150 moves to the run position.

### <Locking and Unlocking of Switchboard Door and Locking and Unlocking of Door Handle Portion>

In the switchboard 1000 according to one embodiment of the present disclosure, the door handle portion 320 disposed on the switchboard door 300 may be open or closed, thereby unlocking or locking a space between the switchboard door 300 and the switchboard case.

Specifically, referring to FIG. 17, the door handle portion 320 is in the closed state. At this time, the door interlock plate 351 does not close the door locking plate insertion groove 311a formed in the door cover edge portion 311.

That is, when the door handle portion 320 is in the closed state, the door interlock plate 351 is located at the first position of opening the door locking plate insertion groove 311a.

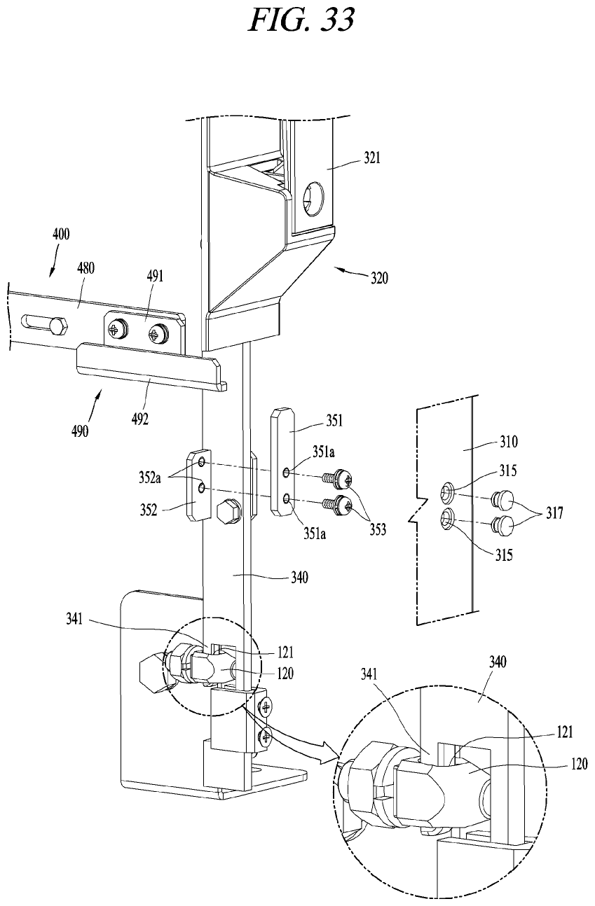

Referring to FIG. 33, when the door handle portion 320 is in the closed state, the door sliding plate 340 is inserted into the door lock pin insertion groove 121 of the door lock pin insertion portion 120, so that the door cover 310 is locked not to be open from the switchboard case.

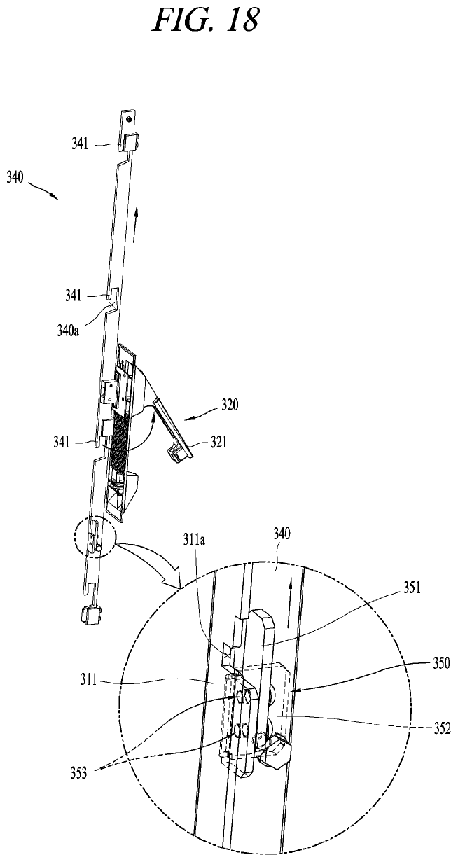

And, referring to FIG. 18, the door handle portion 320 is in the open state. At this time, the door interlock plate 351 closes the door locking plate insertion groove 311a formed in the door cover edge portion 311.

That is, when the door handle portion 320 is in the open state, the door interlock plate 351 is located at the second position of closing the door locking plate insertion groove 311a is closed.

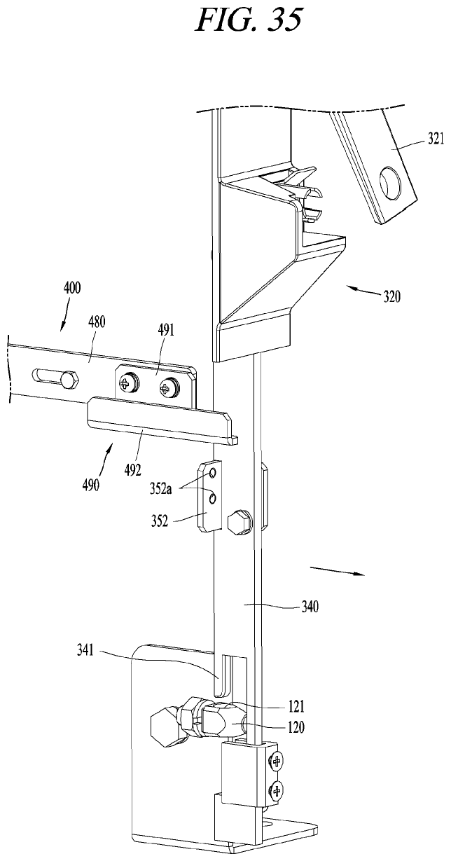

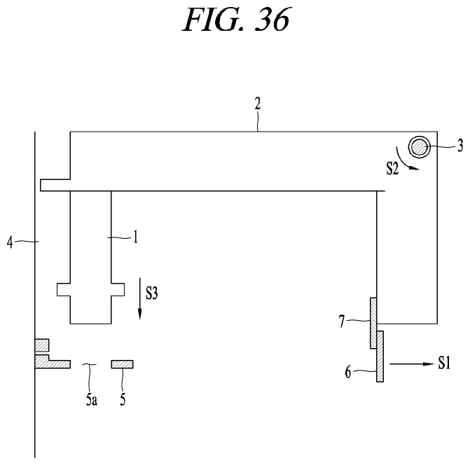

Referring to FIG. 35, when the door handle portion 320 is in the open state, the door sliding plate 340 is pulled out of the door lock pin insertion groove 121 of the door lock pin insertion portion 120, so that the door cover 310 is unlocked to be open from the switchboard case.

Meanwhile, in a state where the switchboard door 300 is locked to the switchboard case, that is, the door cover 310 is coupled to the switchboard case and the door handle portion 320 is locked, the door locking rod 480 may be inserted through at least a portion of the switchboard door 300, so as to lock the door handle portion 320 not to be open.

By locking the door handle portion 320 from being open, the door cover 310 can be locked not to be open from the switchboard 1000.

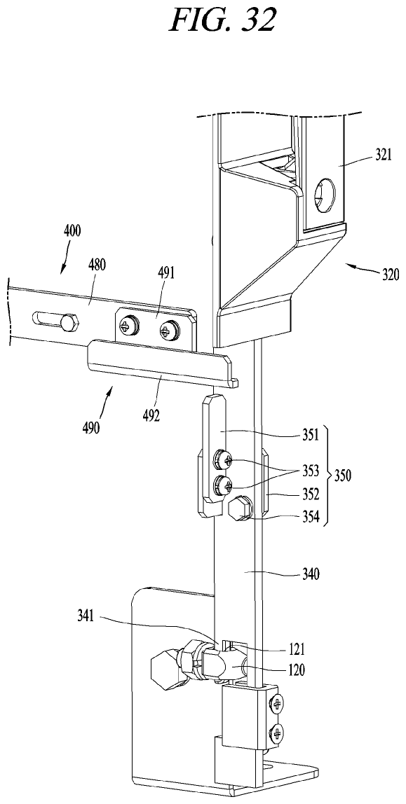

Specifically, referring to FIGS. 25, 27, and 32, the door locking plate 490 is inserted through the door locking plate insertion groove 311a formed in the door cover edge portion 311, so as to be disposed on the upper portion of the door interlock plate 351.

Accordingly, the door interlock plate 351 inserted into the door locking plate insertion groove 311a restricts the movement of the door interlock plate 351.

In the switchboard 1000 according to one embodiment of the present disclosure, as the circuit breaker 150 is inserted, the door locking plate 490 is inserted into the door cover 310, so as to restrict the door handle portion 320 from being switched from the locked state to the open state. Through this, according to the position of the circuit breaker 150 inside the switchboard case, the door locking rod 480 and the door locking plate 490 can be inserted into the door cover 310, and the door handle portion 320 can be locked not to be switched from the locked state to the open state.

Hereinafter, a through hole 315 formed through the door cover 310, a through hole stopper 317, and a resulting mechanism will be described.

The door cover 310 may include a through hole 315 that is formed at a position corresponding to the coupling member 353 when the coupling member 353 is located at the first position.

Specifically, referring to FIG. 33, the through hole 315 may be formed through the door cover 310 at a position where the coupling member 353, by which the door interlock plate 351 and the connection plate 352 of the door interlock plate portion 350 are coupled to each other, corresponds to the door cover 310.

In addition, the door cover 310 may further include a through hole stopper 317 that is at least partially fitted into the through hole 315 and is detachable from the through hole 315.

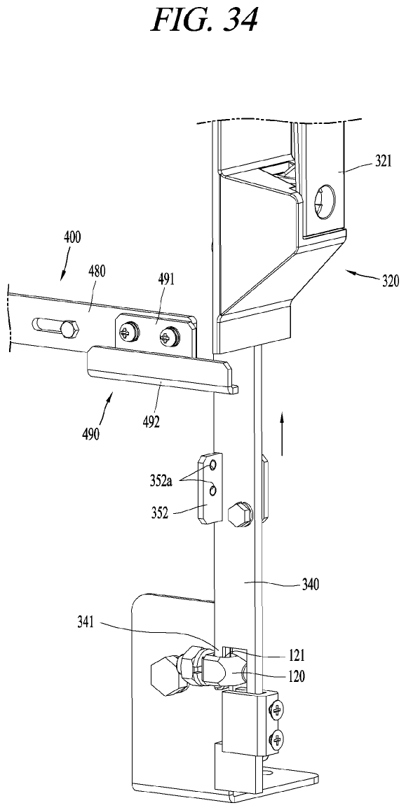

Specifically, referring to FIG. 34 and the like, the through hole stopper 317 may be formed so that at least a portion of the through hole stopper 317 is fitted into the through hole 315. And, the through hole stopper 317 is formed to close the through hole 315. Meanwhile, the through hole stopper 317 may be easily detached from the through hole 315. Accordingly, the coupling member 353, through which the door interlock plate 351 and the connection plate 352 are coupled to each other, can be visible from the outside through the through hole 315.

In addition, the through hole 315 may be formed such that a fastening tool (not shown), for example, a driver, can pass therethrough to separate the coupling member 353 that couples the door interlock plate 351 and the connection plate 352.

Specifically, when the through hole stopper 317 is detached from the through hole 315, the user can insert the fastening tool into the through hole 315. The user can separate the coupling member 353, by which the door interlock plate 351 and the connection plate 352 are coupled to each other, using the fastening tool.

As the coupling member 353 that couples the door interlock plate 351 and the connection plate 352 to each other is separated, the door interlock plate 351 is separated from the connection plate 352. Then, the door interlock plate 351 is separated from the door sliding plate 340. Specifically, referring to FIGS. 34 and 35, the door interlock plate 351 is removed from the door sliding plate 340.

The coupling member 353 connecting the connection plate 352 and the door interlock plate 351 may be disposed in a direction toward the door cover 310 and may be detachable in the direction toward the door cover 310.

In addition, when the door interlock plate 351 is separated from the connection plate 352, the door sliding plate 340 may move upward as the door handle portion 320 is switched from the closed state to the open state after the door locking rod 480 is inserted through the door locking plate insertion groove 311a.

Specifically, referring to FIG. 33 and the like, when the coupling member 353 connecting the connection plate 352 and the door interlock plate 351 is removed, the door interlock plate 351 is removed from the door sliding plate 340.

And, referring to FIGS. 34 and 35, in the door sliding plate 340 from which the door interlock plate 351 has been removed, the door handle portion 320 may be switched from the closed state to the open state even when the door locking plate 490 protrudes toward the door cover 310.

As the door handle portion 320 is switched from the closed state to the open state, the door sliding plate 340 is moved upward. Accordingly, the door lock pin 341 inserted into the door lock pin insertion groove 121 may be pulled out, and the door cover 310 may be separated from the switchboard case, thereby opening the switchboard door.

In addition, in the switchboard 1000 according to one embodiment of the present disclosure, the door sliding plate 340 and the door interlock plate portion 350 can be separated from each other through the through hole 315 and the through hole stopper 317 of the door cover 310. Accordingly, the door sliding plate 340 can be moved up and down. That is, by separating the door sliding plate 340 and the door interlock plate portion 350 from each other, the locked door handle portion 320 locked by the door locking rod 480 and the door locking plate 490 can be unlocked.

That is, when the door handle portion 320 is in the locked state by the door locking rod 480 and the door locking plate 490, the door sliding plate 340 and the door interlock plate portion 350 may be separated from each other through the through ole 315 formed in the door cover 310, thereby releasing the locked state of the door handle portion 320.

Through this, when the door handle portion 320 is in the locked state due to the circuit breaker 150 being disposed inside the switchboard case and simultaneously it is necessary to separate the door cover 310 from the switchboard case, the door sliding plate 340 and the door interlock plate portion 350 can be separated from each other by removing the through hole stopper 317 disposed on the door cover 310. This can provide an advantage of releasing the locked state of the door handle portion 320 in a simple way.

So far, the embodiments of the present disclosure have been described above. However, the scope of the present disclosure is not limited to the above-described embodiments, and various modifications and variations are made by those skilled in the art using the basic concept of the present disclosure as defined in the appended claim, without departing from the scope of the present disclosure.

1. A shutter assembly that is connected to a switchboard to open and close a terminal of an external terminal disposed in the switchboard to be connected to a circuit breaker, the shutter assembly comprising:
a plurality of shutter plates that shield an upper terminal and a lower terminal;
a plurality of shutter levers, each of which is connected to the shutter plate at one end thereof and is rotatable; and
a connection link that connects the plurality of shutter levers and is movable so that the shutter levers rotate,
wherein the plurality of shutter levers are configured to be rotated in different directions so that the plurality of shutter plates are rotated in different directions.

2. The shutter assembly of claim 1, wherein the plurality of shutter plates comprise:
an upper shutter plate that blocks an external terminal disposed at a top; and
a lower shutter plate that blocks an external terminal disposed at a bottom,
the shutter levers comprise:
an upper shutter lever that is connected to the upper shutter plate; and
a lower shutter lever that is connected to the lower shutter plate,
the upper shutter lever and the lower shutter lever include rotation axis pins that rotate the upper shutter lever and the lower shutter lever, respectively, and
the rotation axis pins of the upper shutter lever and the lower shutter lever are disposed at the same position of each lever.

3. The shutter assembly of claim 2, further comprising a main link that is connected to the connection link to move the connection link downward when the circuit breaker is inserted,
wherein the main link is disposed in a path along which the circuit breaker is inserted into the switchboard, and pressed by at least a portion of the circuit breaker as the circuit breaker is inserted, to be rotated centering on one axis, and
the main link includes a stopping jaw by which a wheel of the circuit breaker is caught, and is rotated when the wheel of the circuit breaker enters more inward than the stopping jaw.

4. The shutter assembly of claim 3, wherein the connection link comprises:
an upper connection link that connects the upper shutter lever and the lower shutter lever to each other; and
a lower connection link that connects the lower shutter lever and the main link to each other, and
the upper connection link and the lower connection link are connected to the upper shutter lever and the lower shutter lever, respectively, at a position farthest away from the rotation axis pin in a remaining region, excluding at least a portion from a region of connecting the rotation axis pin and the shutter plate, so as to be connected to the shutter plates.

5. The shutter assembly of claim 4, wherein the upper connection link is connected to the upper shutter lever at a side far away from the shutter plate based on the rotation axis pin, and
the lower connection link is connected to the lower shutter lever at a side close to the shutter plate based on the rotation axis pin.

6. The shutter assembly of claim 1, further comprising a locking device that has at least a portion locking the shutter plate,
wherein the locking device comprises:
a rotation part that is disposed adjacent to the shutter plate and is rotatable;
a shutter locking plate that is coupled to the rotation part to be rotated in response to rotation of the rotation part;
a connecting rotation plate that is disposed to be spaced apart from the rotation part and rotated by being pressed by a circuit breaker body during a process that the circuit breaker is inserted into the switchboard; and
a connecting rod that is coupled to each of the rotation part and the connecting rotation plate to transmit rotational force generated by the connecting rotation plate to the rotation part,
wherein the shutter locking plate is disposed in a blocking area, in which the shutter locking plate blocks the shutter plate, before the connecting rotation plate is rotated by the circuit breaker, and is rotatable to outside of the blocking area of the shutter plate when the circuit breaker is inserted into the switchboard and the connecting rotation plate is rotated by the circuit breaker.

7. The shutter assembly of claim 6, wherein the circuit breaker changes a position to:
a first state in which the circuit breaker is disposed in a disconnected state inside the switchboard;
a second state in which the circuit breaker is disposed in a test state inside the switchboard; and
a third state in which the circuit breaker is disposed in a connected state connected to the external terminal inside the switchboard, and
the connecting rotation plate is configured to be pressed by the circuit breaker body in the process that the circuit breaker is switched from the second state to the third state.

8. The shutter assembly of claim 6, wherein the rotation part comprises:
a fixed plate that is fixed to a fixing portion inside the switchboard, adjacent to the shutter plate;
a lower plate that is disposed adjacent to a lower surface of a switchboard case corresponding to the fixing plate;
a rotation rod that has one side coupled to the fixed plate and another side coupled to the lower plate and is rotatable; and
a rotation part plate that is coupled to be rotatable relative to the lower plate and rotatable in response to rotation of the rotation rod.

9. The shutter assembly of claim 8, wherein the connecting rod comprises a first groove, a second groove, and a third groove that are formed in a line in one end thereof connected to the rotation part plate, and disposed to be spaced apart from one another, and
the rotation part plate comprises:
a first hole that is formed at a position corresponding to the first groove as the rotation part plate is rotated in one direction;
a second hole that is connected to the second groove by a rotation pin and serves as a center of a rotation axis; and
a third hole that is formed at a position corresponding to the third groove as the rotation part plate is rotated in another direction.

10. The shutter assembly of claim 6, further comprising a door locking rod that has one end connected to the connecting rotation plate,
wherein the door locking rod is coupled to a portion opposite to a portion where the connecting rod is coupled to the connecting rotation plate, so as to be moved in an opposite direction to the connecting rod during the rotation of the connecting rotation plate.

11. The shutter assembly of claim 10, wherein the door locking rod comprises a connecting portion protruding to one side thereof, and
the connecting portion is configured such that a coupling bolt coupled to the connecting rotation plate is coupled thereto.

12. The shutter assembly of claim 10, further comprising a door locking plate that is coupled to another end of the door locking rod and extends in a direction parallel to a lengthwise direction of the door locking rod, and
wherein the door locking plate is moved in the lengthwise direction of the door locking rod to be inserted into a door locking plate insertion groove formed in a door, in response to the rotation of the connecting rotation plate.

13. A locking device disposed inside a switchboard to lock or unlock a shutter assembly for opening and closing a terminal of an external terminal, the locking device comprising:
a rotation part that is disposed adjacent to a shutter plate of the shutter assembly and is rotatable;
a shutter locking plate that is coupled to the rotation part and rotated in response to rotation of the rotation part;
a connecting rotation plate that is disposed to be spaced apart from the rotation part and rotated by being pressed by a circuit breaker body during a process that a circuit breaker is inserted into the switchboard; and
a connecting rod that is coupled to each of the rotation part and the connecting rotation plate to transmit rotational force generated by the connecting rotation plate to the rotation part,
wherein the shutter locking plate is disposed in a blocking area, in which the shutter locking plate blocks the shutter plate, before the connecting rotation plate is rotated by the circuit breaker, and
is rotatable to outside of the blocking area of the shutter plate when the circuit breaker is inserted into the switchboard and the connecting rotation plate is rotated by the circuit breaker.

14. A switchboard comprising:
a switchboard case in which a circuit breaker is mounted to be movable to a test position and a connected position;
a door that is installed on the switchboard case to be open and closed;
a shutter assembly that is configured to open and close terminals disposed inside the switchboard case as the circuit breaker is moved into the switchboard case; and
a locking device that is disposed in a region where the same locks the shutter assembly when the shutter assembly is rotated, and is rotated to a region where the same does not lock the shutter assembly to allow the shutter assembly to be rotated as the circuit breaker is moved into the switchboard case.

15. The switchboard of claim 14, wherein the shutter assembly comprises:
a plurality of shutter plates that shield an upper terminal and a lower terminal;
a plurality of shutter levers, each of which has one end connected to the shutter plate and is rotatable;
a connection link that connects the plurality of shutter levers and is movable so that the shutter levers rotate;
a main link that is connected to the connection link to move the connection link downward when the circuit breaker is inserted, and
the plurality of shutter levers are configured to be rotated in different directions so that the plurality of shutter plates are rotated in different directions.

16. The switchboard of claim 15, wherein the locking device comprises:
a rotation part that is disposed adjacent to the shutter plate of the shutter assembly and is rotatable;
a shutter locking plate that is coupled to the rotation part and rotated in response to rotation of the rotation part;
a connecting rotation plate that is disposed to be spaced apart from the rotation part and rotated by being pressed by a circuit breaker body during a process that a circuit breaker is inserted into the switchboard; and
a connecting rod that is coupled to each of the rotation part and the connecting rotation plate to transmit rotational force generated by a second rotation plate to a first rotation plate, and
the shutter locking plate is disposed in a blocking area, in which the shutter locking plate blocks the shutter plate, before the connecting rotation plate is rotated by the circuit breaker, and
is rotatable to outside of the blocking area of the shutter plate when the circuit breaker is inserted into the switchboard and the connecting rotation plate is rotated by the circuit breaker.

17. The switchboard of claim 15, wherein the main link comprises a stopping jaw by which a wheel of the circuit breaker is caught, and is rotated when the wheel of the circuit breaker enters more inward than the stopping jaw, and
the stopping jaw of the main link is disposed closer to a rear surface of the switchboard case than the connecting rotation plate.

18. The switchboard of claim 15, wherein the locking device comprises:
a door locking rod that suppresses the door from being arbitrarily open when the circuit breaker moves to the run position.

19. The switchboard of claim 14, further comprising a switchboard door that is connected to a front surface of the switchboard case and disposed to open and close the switchboard case,
the switchboard door comprises:
a door cover that is rotatable relative to the switchboard case;
a door handle portion that is disposed on one side of the door cover and is open or closed to lock or unlock the door cover with respect to the switchboard case; and
a door sliding plate that is movable in one direction in conjunction with an opening or closing operation of the door handle portion,
the door cover comprises a door locking plate insertion groove through which a door locking rod is inserted, the door locking rod protruding toward the door cover or being drawn in according to an inserted state of the circuit breaker into the switchboard case.

20. The switchboard of claim 19, wherein the door cover further comprises:
a hinge member that is coupled to the switchboard case and serves as a rotation axis of the door cover; and
a door cover edge portion that is disposed on an opposite side to a side where the hinge member is disposed, and protrudes toward an inside of the door cover, and
the door locking plate insertion groove is formed at a position corresponding to the door locking rod at the door cover edge portion.

21. The switchboard of claim 20, wherein the door sliding plate further comprises a door interlock plate portion that is disposed to cover or not to cover the door locking plate insertion groove as the door sliding plate is moved up and down.

22. The switchboard of claim 21, wherein the door interlock plate portion comprises:
a connection plate that has one end coupled to the door sliding plate to be movable together with the door sliding plate as the door sliding plate is moved up and down;
a door interlock plate that is coupled to another end of the connection plate, and is disposed at a first position to open the door locking plate insertion groove when the door handle portion is in a closed state while being disposed at a second position to close the door locking plate insertion groove when the door handle portion is in an open state; and
a coupling member that couples the connection plate and the door interlock plate to each other.

23. The switchboard of claim 22, wherein the circuit breaker changes a position to:
a first state in which the circuit breaker is disposed in a disconnected state inside the switchboard;
a second state in which the circuit breaker is disposed in a test state inside the switchboard; and
a third state in which the circuit breaker is disposed in a connected state connected to an external terminal inside the switchboard,
the door locking rod is inserted through the door locking plate insertion groove in the process that the circuit breaker is switched from the second state to the third state, and
the door interlock plate is restricted from being moved from the first position to the second position by the door locking rod, which is pulled out through the door locking plate insertion groove, when the door locking rod is disposed in a state inserted through the door locking plate insertion groove.

24. The switchboard of claim 23, wherein the coupling member is disposed in a direction toward the door cover to be detachable in the direction toward the door cover, and
the door cover comprises a through hole formed at a position corresponding to the coupling member when the coupling member is located at the first position.

25. The switchboard of claim 24, wherein the door cover further comprises a through hole stopper that is at least partially fitted into the through hole and detachable from the through hole.
